(19) United States
(12) Patent Application Publication
(10) Pub. No.: US 2026/0203323 A1
(43) Pub. Date: Jul. 16, 2026

(54) INFORMATION PROCESSING APPARATUS, INFORMATION PROCESSING METHOD, AND NON-TRANSITORY RECORDING MEDIUM

(71) Applicant: Naoyuki SHIMIZU, Kanagawa (JP)

(72) Inventor: Naoyuki SHIMIZU, Kanagawa (JP)

(21) Appl. No.: 19/444,190

(22) Filed: Jan. 9, 2026

(30) Foreign Application Priority Data
Jan. 15, 2025 (JP) 2025-005690

(51) Int. Cl. G06F 16/3329

(52) U.S. Cl. CPC G06F 16/33295

(57) ABSTRACT

An information processing apparatus includes circuitry to receive a registration request to store a file in a memory, generate a prompt to output content derived from an object included in the file, transmit the prompt and the object to a large-scale language model, store, in the memory, a result output by the large-scale language model in association with the file, search the memory for the file to obtain answer data that is to be generated based on the file, in response to input of question data received via a terminal apparatus, and output, to the terminal apparatus, the answer data based on the file.

### CROSS-REFERENCE TO RELATED APPLICATIONS

This patent application is based on and claims priority pursuant to 35 U.S.C. § 119(a) to Japanese Patent Application No. 2025-005690, filed on Jan. 15, 2025, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

In recent years, various approaches have been employed to increase the accuracy of answers in response systems that output answer data to questions input by text or voice. For example, answers including a word included in a question are searched for, and screen information for editing at least one or more answers found by the search on a terminal apparatus of a system administrator is generated.

In the related art, when registering information for use in generating answer data to questions, if the user attempts to register an answer based on information that can be read from a file, the user verifies the content of the information of the file and input the information as text.

### SUMMARY

The present disclosure described herein provides an information processing apparatus including circuitry to receive a registration request to store a file in a memory, generate a prompt to output content derived from an object included in the file, transmit the prompt and the object to a large-scale language model, store, in the memory, a result output by the large-scale language model in association with the file, search the memory for the file to obtain answer data that is to be generated based on the file, in response to input of question data received via a terminal apparatus, and output, to the terminal apparatus, the answer data based on the file.

The present disclosure described herein provides an information processing method performed by an information processing apparatus. The information processing method includes receiving a registration request to store a file in a memory, generating a prompt to output content derived from an object included in the file, transmitting the prompt and the object to a large-scale language model, storing, in the memory, a result output by the large-scale language model in association with the file, searching the memory for the file to obtain answer data that is based on the file, in response to question data received via a terminal apparatus connected to the information processing apparatus, and outputting, to the terminal apparatus, the answer data based on the file.

The present disclosure described herein provides a non-transitory recording medium storing a plurality of instructions which, when executed by one or more processors, causes the one or more processors to perform a method. The method includes receiving a registration request to store a file in a memory, generating a prompt to output content derived from an object included in the file, transmitting the prompt and the object to a large-scale language model, storing, in the memory, a result output by the large-scale language model in association with the file, searching the memory for the file to obtain answer data that is based on the file, in response to question data received via a terminal apparatus, and outputting, to the terminal apparatus, the answer data based on the file.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a chat system;

FIG. 2 is a block diagram illustrating a hardware configuration of an information processing apparatus;

FIG. 3 is a block diagram illustrating a hardware configuration of a terminal apparatus;

FIG. 4 is a diagram illustrating functional configurations of apparatuses or devices included in the chat system of FIG. 1;

FIG. 5 is a diagram illustrating an example of a conversation history database (DB) included in a first storage device;

FIG. 6 is a diagram illustrating an example of a document DB included in a second storage device;

FIG. 7 is a diagram illustrating an example of a chunk DB included in the second storage device;

FIG. 8 is a diagram illustrating an example of a user information DB included in the second storage device;

FIG. 9 is a first sequence diagram illustrating an operation performed by the chat system of FIG. 1;

FIG. 10 is a diagram illustrating an example of an internal information registration screen according to a first embodiment;

FIG. 11 is a diagram illustrating an example of internal information according to the first embodiment;

FIG. 12 is a diagram illustrating an analysis result obtained by analyzing internal information by an analysis server;

FIG. 13 is a diagram illustrating an example prompt according to the first embodiment;

FIG. 14 is a diagram illustrating an example of a result that is a textual description of an object obtained by a large-scale language model according to the first embodiment;

FIG. 15 is a diagram illustrating an example of internal information represented as a textual representation;

FIG. 16 is a first sequence diagram illustrating an operation performed by the chat system of FIG. 1;

FIG. 17 is a diagram illustrating a display example when question data is input to a terminal apparatus;

FIG. 18 is a diagram illustrating an example of internal information according to a second embodiment;

FIG. 19 is a diagram illustrating an example prompt according to the second embodiment;

FIG. 20 is a diagram illustrating an example of a result that is a textual description of an object obtained by a large-scale language model according to the second embodiment;

FIG. 21 is a diagram illustrating an example screen displayed on a terminal apparatus according to the second embodiment;

FIG. 22 is a sequence diagram illustrating an operation performed by the chat system of FIG. 1 according to a third embodiment;

FIG. 23 is a diagram illustrating an example prompt according to the third embodiment;

FIG. 24 is a diagram illustrating an example of internal information according to a fourth embodiment; and

FIG. 25 is a diagram illustrating an example of an internal information registration screen according to the first embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

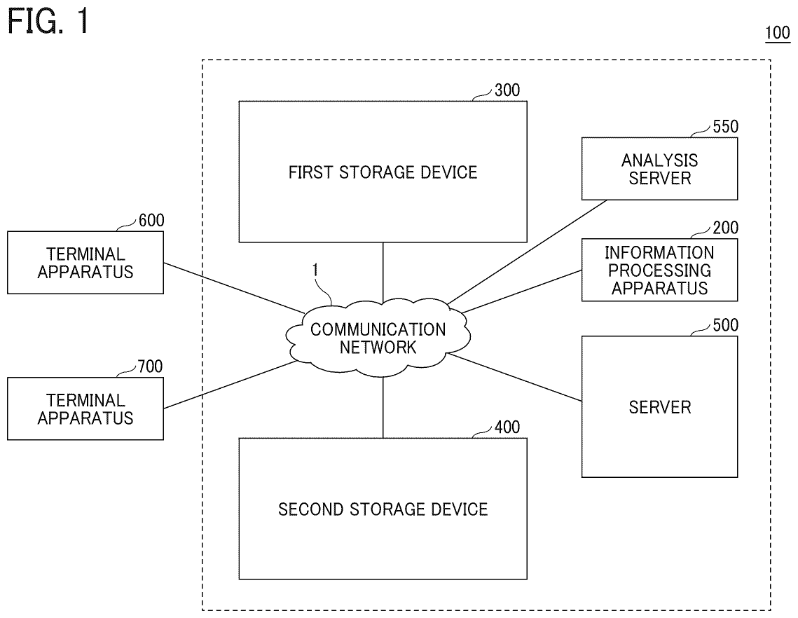

FIG. 1 is a diagram illustrating a system configuration of a chat system 100 according to a first embodiment.

The chat system 100, which is an example of an information processing system, includes an information processing apparatus 200, a first storage device 300, a second storage device 400, a server 500, an analysis server 550, a terminal apparatus 600, and a terminal apparatus 700, which are connected to each other via a communication network 1.

The chat system 100 is, for example, an information processing apparatus implemented by a computer or an information processing system implemented by a plurality of computers. The chat system 100 may be, for example, an interactive agent that interacts with a user via the terminal apparatus 600. The chat system 100 is a program or a system for responding to a question from, for example, a user of the terminal apparatus 600. The chat system 100 provides a service for automatically responding by using, for example, artificial intelligence (AI) or knowledge including registered information and knowledges, and is also called an AI agent. Preferably, the chat system 100 supports execution of a predetermined task, such as a help desk task or a business negotiation, through interaction in which the chat system automatically responds to a voice or an input message from the user. The chat system 100 is used, for example, in a web conference, a website, or an application for a smartphone, or as an unmanned AI avatar in a virtual space of a metaverse (referred to as a metaverse space in the following description).

In the chat system 100, the information processing apparatus 200, the first storage device 300, the second storage device 400, the server 500, and the analysis server 550 operate in cooperation to provide a chatbot service to the user of the terminal apparatus 600.

When a question is input at the terminal apparatus 600, the information processing apparatus 200 outputs to the terminal apparatus 600 an answer to the input question.

The first storage device 300 stores conversation history information in which questions input from the terminal apparatus 600 are associated with answers output to the terminal apparatus 600. The conversation history information may be managed for each tenant that uses the chat system 100. In the present embodiment, the tenant may be an organization to which the user who uses the chat system 100 belongs, such as a company for which the user works.

The second storage device 400 stores user-specific information specific to the user, such as private information that is not publicly disclosed. The user of the chat system 100 may be, for example, the tenant. In such a case, the user-specific information corresponds to information specific to the tenant. Alternatively, the user of the chat system 100 may be an individual user. In such a case, the user-specific information corresponds to information specific to the individual user.

In the following description, user-specific information is referred to as internal information, and internal information is an example of user-specific information. In this embodiment, the user-specific information is a file stored in a memory containing one or more objects, and is searched to output answer data when question data is input from a user. The objects will be described in detail later.

Internal information is data managed by an organization to which multiple members belong, and may include data stored in a database managed by the organization. Examples of organizations may include a for-profit organization such as a company and a non-profit organization such as a hospital, a school, or a cram school. As an example, internal information managed by the hospital includes information on a patient, such as a medical record. In this case, the chat system 100 can generate answer data including diagnosis details based on the information on the patient. In another example, internal information managed by the school or the cram school includes information on the learning status or academic performance of a user such as a student. In this case, the chat system 100 can generate answer data including an appropriate exercise or a video lesson based on the information on the learning status or the academic performance.

The second storage device 400 may store internal information for each tenant. In the second storage device 400, predetermined information units obtained by dividing internal information are stored. Specifically, each unit of the internal information obtained by dividing the internal information is stored. In the following description, each divided unit of the internal information is referred to as a chunk or chunk data. The second storage device 400 may store user information on users belonging to a tenant for each tenant.

In this disclosure, the file may be any file stored in a storage unit and used by generative artificial intelligence (AI) described later to output answers to questions, and is not limited to user-specific information (internal information). The file may be present without including any objects.

The server 500 implements generative AI. The generative AI generates text according to a prompt being input, and outputs the generated text to the information processing apparatus 200. Chat Generative Pretrained Transformer (GPT) is one example of the generative AI. The prompt is text data that describes an instruction or a question to the server 500 operating as the generative AI. A large-scale language model will be described in detail later.

Internal information is input, and the analysis server 550 analyzes internal information. Specifically, when the internal information includes information other than text data, such as an object, a table, or an image, the analysis server 550 detects the information other than text data and extracts the detection result as an image. In the following description, information or data other than text data refers to non-text data. In the following description, information other than text data included in the internal information may be represented as an object included in the internal information. The object may include graphic data represented as a line drawing, tabular data, and image data such as a photograph.

In addition, when an object is included in the internal information, the analysis server 550 extracts image data of the object and a caption (heading) of the object as an image. The caption (heading) of an object is, in other words, information on the object. Then, the analysis server 550 outputs the image data representing the image of the object and the image data representing the image of the caption to the information processing apparatus 200.

The terminal apparatus 600 is operated, for example, by a user who uses the chat system 100. The terminal apparatus 700 is operated, for example, by an administrator who manages the chat system 100. The terminal apparatus 600 and the terminal apparatus 700 may be, for example, a smartphone or a tablet terminal.

In the chat system 100, when a question is input by a user to the terminal apparatus 600, the terminal apparatus 600 transmits question data indicating the question to the information processing apparatus 200.

In response to receiving the question data from the terminal apparatus 600, the information processing apparatus 200 obtains, from the first storage device 300, conversation history information for a certain period of time before the question is input to the terminal apparatus 600. Then, the information processing apparatus 200 outputs, to the server 500, a prompt requesting to generate a query (search key) for searching for a chunk stored in the second storage device 400, using the input question and the obtained conversation history information.

The server 500 inputs the prompt requesting to generate a query to the large-scale language model and transmits output data output from the large-scale language model to the information processing apparatus 200. The information processing apparatus 200 searches the second storage device 400 using the output data received from the server 500 as a query, and obtains a chunk that is a search result.

The information processing apparatus 200 outputs, to the server 500, a prompt requesting to generate an answer to the question input via the terminal apparatus 600 by using, as an information source, the chunk obtained as the search result.

The server 500 inputs, to the large-scale language model, the prompt requesting to generate an answer, and transmits output data output from the large-scale language model to the information processing apparatus 200.

The information processing apparatus 200 transmits the output data received from the server 500 to the terminal apparatus 600 as answer data.

The terminal apparatus 600 displays the answer data received from the information processing apparatus 200 as an answer to the input question.

As described above, an answer to a question can be generated by the large-scale language model based on user-specific information that is not publicly disclosed. The chat system 100 thus provides a response based on the user-specific information.

As an information source for generating an answer to a question, the chat system 100 uses internal information, which is obtained as a result of searching the second storage device 400 based on conversation history information representing a conversation before the question is input. Further, an amount of internal information to be referred to as the information source is controlled before the internal information is transmitted to the server 500. This increases the accuracy of the answer, while controlling the number of inputs to fit within the token limits of the large-scale language model.

In the chat system 100, when the information processing apparatus 200 receives, from the terminal apparatus 700, a request to store internal information including an object in the second storage device 400, the information processing apparatus 200 stores the internal information including an object in a document database (DB) 410.

The information processing apparatus 200 obtains image data that represents an object included in internal information from the analysis server 550 and transmits, to the server 500, a prompt requesting a textual description (textual representation) of an image, which is represented by the obtained image data. The image is an object included in the internal information. Then, the information processing apparatus 200 replaces text data received from the server 500 with the object included in the internal information, divides the text data into chunks, and stores each chunk in the second storage device 400. That is, the chunk is a unit of text data and obtained by dividing the internal information in which the content that can be derived (read) from the object included in the file is represented as a textual description.

As described above, in the chat system 100, an object included in internal information is replaced with text data represented as a textual description, and the internal information including the text data is stored in the second storage device 400. Accordingly, according to the present embodiment, the internal information including an object can be also used as an information source in generating an answer using the large-scale language model. In other words, this supports the task of registering answers based on information that is readable from a file. Further, according to the present embodiment, an answer can be generated using an object included in a file as an information source for the answer.

In the example of FIG. 1, the information processing apparatus 200, the first storage device 300, and the second storage device 400 are illustrated as separate apparatuses or devices), but any one of these apparatuses or devices may be combined into one apparatus or device. For example, the first storage device 300 and the second storage device 400 may be included in the information processing apparatus 200. Also, in the example of FIG. 1, the information processing apparatus 200 and the analysis server 550 are illustrated as separate apparatuses (devices). However, the configuration is not limited thereto.

The analysis server 550 may be included in the information processing apparatus 200. In other words, the information processing apparatus 200 may also have the functionality of the analysis server 550.

In FIG. 1, the information processing apparatus 200 may be implemented by one or more information processing apparatuses, such that a plurality of information processing apparatuses 200 may be illustrated.

Alternatively, the chat system 100 may only include the information processing apparatus 200 and the terminal apparatus 600, such that any other apparatus may not be included in the chat system 100.

An example hardware configuration of each apparatus or device included in the chat system 100 is described below.

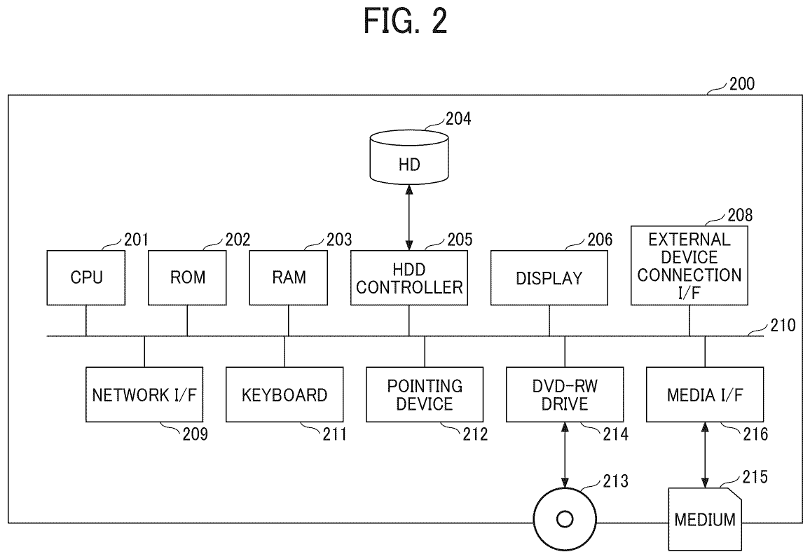

The information processing apparatus 200, the first storage device 300, the second storage device 400, the server 500, and the analysis server 550 are each implemented by the general-purpose computer. As an example, a hardware configuration of the information processing apparatus 200 is described below with reference to FIG. 2.

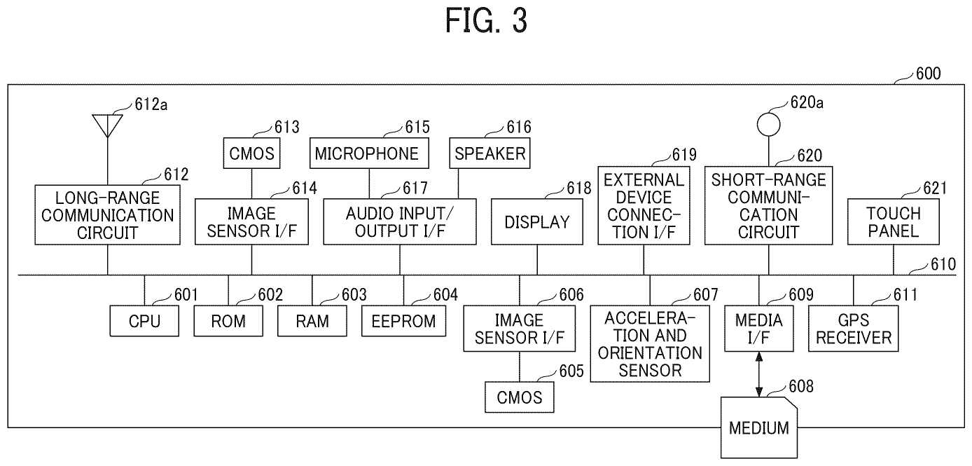

The terminal apparatuses 600 and 700 are each implemented by a smartphone. An example hardware configuration of the terminal apparatus 600 is described below with reference to FIG. 3.

FIG. 2 is a block diagram illustrating a hardware configuration of the information processing apparatus 200. The information processing apparatus 200 illustrated in FIG. 2, which is implemented by a computer, includes a central processing unit (CPU) 201, a read-only memory (ROM) 202, a random-access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a Digital Versatile Disk Rewritable (DVD-RW) drive 214, and a media I/F 216.

The CPU 201 controls the overall operation of the information processing apparatus 200. The ROM 202 stores a program such as an IPL used for booting the CPU 201. The RAM 203 is used as a work area for the CPU 201. The HD 204 stores various data such as a program. The HDD controller 205 controls the reading of various data from, or the writing of various data to, the HD 204 under the control of the CPU 201. The display 206 displays various types of information, such as a cursor, a menu, a window, text, or an image. The external device connection I/F 208, which may be implemented by an interface circuit, is an interface for connection with various external devices. Examples of the external devices include, but not limited to, a universal serial bus (USB) memory and a printer.

The network I/F 209, which may be implemented by an interface circuit, is an interface for data communication through a communication network. The bus line 210 is, for example, an address bus or a data bus that electrically connects the components illustrated in FIG. 2, such as the CPU 201.

The keyboard 211 is an example of an input device provided with a plurality of keys for allowing a user to input characters, numerals, or various instructions. The pointing device 212 is an example of an input device that allows selection or execution of various instructions, selection of a processing target, and movement of a cursor. The DVD-RW drive 214 controls the reading of various data from, or the writing of various data to, a DVD-RW 213, which is an example of a removable recording medium. The removable recording medium is not limited to a DVD-RW and may be, for example, a digital versatile disc recordable (DVD-R). The media I/F 216 controls the reading of data from, or the writing (storing) of data to (in), a recording medium 215 such as a flash memory.

FIG. 3 is a block diagram illustrating a hardware configuration of the terminal apparatus 600. The terminal apparatus 600 according to the present embodiment includes a CPU 601, a ROM 602, a RAM 603, an electrically erasable programmable read-only memory (EEPROM) 604, a complementary metal oxide semiconductor (CMOS) sensor 605, an image sensor I/F 606, an acceleration and orientation sensor 607, a media I/F 609, and a global positioning system (GPS) receiver 611.

The CPU 601 is an arithmetic processing unit, which controls entire operation of the terminal apparatus 600. The ROM 602 stores a control program for controlling the CPU 601, such as an initial program loader (IPL). The RAM 603 is used as a work area for the CPU 601. The EEPROM 604 reads or writes various data such as a control program for a smartphone under control of the CPU 601. The ROM 602, the RAM 603, and the EEPROM 604 are examples of storage devices for the terminal apparatus 600.

The CMOS sensor 605 is an example of a built-in imaging device that captures an image of a subject (e.g., a self-image of the user) under the control of the CPU 601 to obtain image data. In alternative to the CMOS sensor 605, imaging means such as a charge-coupled device (CCD) sensor may be used.

The image sensor I/F 606 is a circuit that controls the driving of the CMOS sensor 605. The acceleration and orientation sensor 607 includes various sensors, such as an electromagnetic compass or gyrocompass for detecting geomagnetism and an acceleration sensor. The media I/F 609 controls the reading of data from, or the writing (storing) of data to (in), a recording medium 608 such as a flash memory. The GPS receiver 611 receives a GPS signal from a GPS satellite.

The terminal apparatus 600 further includes a long-range communication circuit 612, an antenna 612a for the long-range communication circuit 612, a CMOS sensor 613, an image sensor I/F 614, a microphone 615, a speaker 616, an audio input/output (I/O) I/F 617, a display 618, an external device connection I/F 619, a short-range communication circuit 620, an antenna 620a for the short-range communication circuit 620, and a touch panel 621.

The long-range communication circuit 612 is a circuit for communicating with other devices via a communication network. The CMOS sensor 613 is an example of a built-in imaging device that captures an image of a subject under the control of the CPU 601 to obtain image data. The image sensor I/F 614 is a circuit that controls the driving of the CMOS sensor 613. The microphone 615 is a built-in circuit that converts sound into electrical signals. The speaker 616 is a built-in circuit that converts electrical signals into physical vibration to produce sound such as music or voice. The audio input/output I/F 617 is a circuit that processes the input and output of audio signals between the microphone 615 and the speaker 616 under the control of the CPU 601.

The display 618 is an example of a display that displays an image of a subject and various icons, and may be implemented by, for example, a liquid crystal display or an organic electro-luminescence (EL) display. The external device connection I/F 619, which may be implemented by an interface circuit, is an interface for connection with various external devices. The short-range communication circuit 620 is a communication circuit in compliance with a communication protocol such as the near field communication (NFC) or Bluetooth®. The touch panel 621, which serves as an input device, allows a user to operate the terminal apparatus 600 by touching a screen of the display 618. The display 618 is an example of a display unit included in the terminal apparatus 600.

The hardware configuration illustrated in FIG. 3 is one example of the hardware configuration of the terminal apparatus 600, such that the terminal apparatus 600 may have a hardware configuration other than that of FIG. 3. For example, the hardware configuration of the terminal apparatus 600 may be the configuration illustrated in FIG. 2.

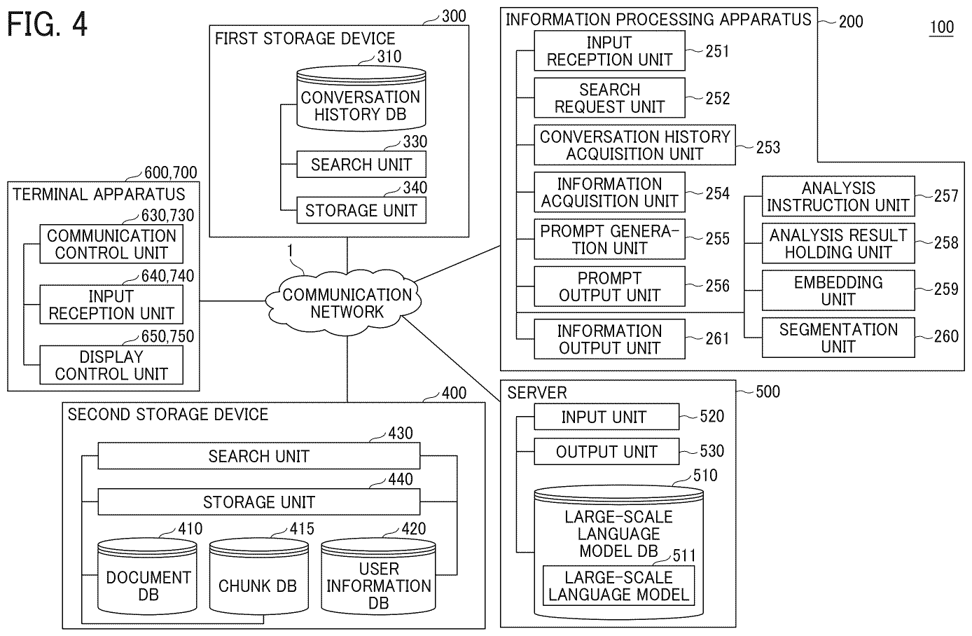

Functions of apparatus or devices included in the chat system 100 are described below with reference to FIG. 4. FIG. 4 is a block diagram illustrating a functional configuration of apparatuses (devices) included in the chat system 100.

The functional configuration of the first storage device 300 is described below. The first storage device 300 includes a conversation history DB 310, a search unit 330 and a storage unit 340.

The conversation history DB 310 may be implemented by, for example, a memory included in the first storage device 300, and the search unit 330 and the storage unit 340 are implemented by the CPU of the first storage device 300 reading and executing programs stored in the memory.

The conversation history DB 310, which is an example of a conversation storage history unit, stores conversation history information in which questions input from the terminal apparatus 600 are associated with answers output to the terminal apparatus 600. The search unit 330 searches the conversation history DB 310 in response to a search request from the information processing apparatus 200, and transmits a search result to the information processing apparatus 200. When question data is input to the information processing apparatus 200 and output answer data is output from the information processing apparatus 200, the storage unit 340 stores conversation history information including the question data and the output answer data in the conversation history DB 310.

The first storage device 300 may also include a DB that stores a set of question and answer information in which a question and an answer are associated with each other. In this case, in response to receiving the input of a question from the terminal apparatus 600, the first storage device 300 can also search the set of question and answer information to output an answer. The question and answer information may be stored for each tenant that has introduced the chat system 100.

The functional configuration of the second storage device 400 is described below. The second storage device 400 includes the document DB 410, a chunk DB 415, a user information DB 420, a search unit 430, and a storage unit 440.

In the second storage device 400, the document DB 410, the chunk DB 415, and the user information DB 420 may be implemented by, for example, a memory included in the second storage device 400, and are provided for each tenant. The search unit 430 and storage unit 440 of the second storage device 400 are implemented by the CPU of the second storage device 400 reading and executing programs stored in the memory.

The document DB 410 stores internal information for each tenant. A unit of internal information obtained by dividing the internal information and stored in the chunk DB 415 is referred to as a chunk. The chunk DB 415 stores chunks of the internal information. The user information DB 420 stores, for each tenant, user information regarding one or more users belonging to the tenant.

The search unit 330 searches the conversation history DB 310 in response to a search request from the information processing apparatus 200, and transmits a search result to the information processing apparatus 200. In response to an operation of uploading internal information by the administrator of the chat system 100, the storage unit 440 newly stores the internal information in the document DB 410. Also, in response to receiving chunks obtained by dividing the internal information from the information processing apparatus 200, the storage unit 440 stores the chunks in the chunk DB 415. The DBs in the first storage device 300 and the second storage device 400 will be described in detail later.

The functional configuration of the server 500 is described below. The server 500 includes a large-scale language model DB 510, an input unit 520, and an output unit 530. The large-scale language model DB 510 stores the large-scale language model 511 for implementing the generative AI.

The large-scale language model 511 is a computer language model that is generated by executing a training process using a huge amount of unlabeled text as training data and includes an artificial neural network having a large number of parameters. The large-scale language model 511 is sufficiently trained by a method for learning a context, such as next-sentence prediction to understand a context by determining whether sentence 1 and sentence 2 are consecutive or a masked language model to understand a context by masking a word in a sentence and predicting the masked word from words that come before and after the masked word, to capture many sentence structures and meanings of human language.

The input unit 520 inputs a prompt transmitted from the information processing apparatus 200 to the large-scale language model 511. The output unit 530 outputs (transmits) output data output from the large-scale language model 511 to the information processing apparatus 200. In other words, the output unit 530 transmits the output answer data output from the large-scale language model 511 to the information processing apparatus 200.

The functional configurations of the terminal apparatuses 600 and 700 are described below. The terminal apparatus 600 includes a communication control unit 630, an input reception unit 640, and a display control unit 650. The terminal apparatus 700 includes a communication control unit 730, an input reception unit 740, and a display control unit 750.

The communication control units 630 and 730 control communication between the terminal apparatuses 600 and 700 and the information processing apparatus 200. The input reception units 640 and 740 receive inputs to the terminal apparatuses 600 and 700, respectively. The display control units 650 and 750 control display in the terminal apparatuses 600 and 700, respectively.

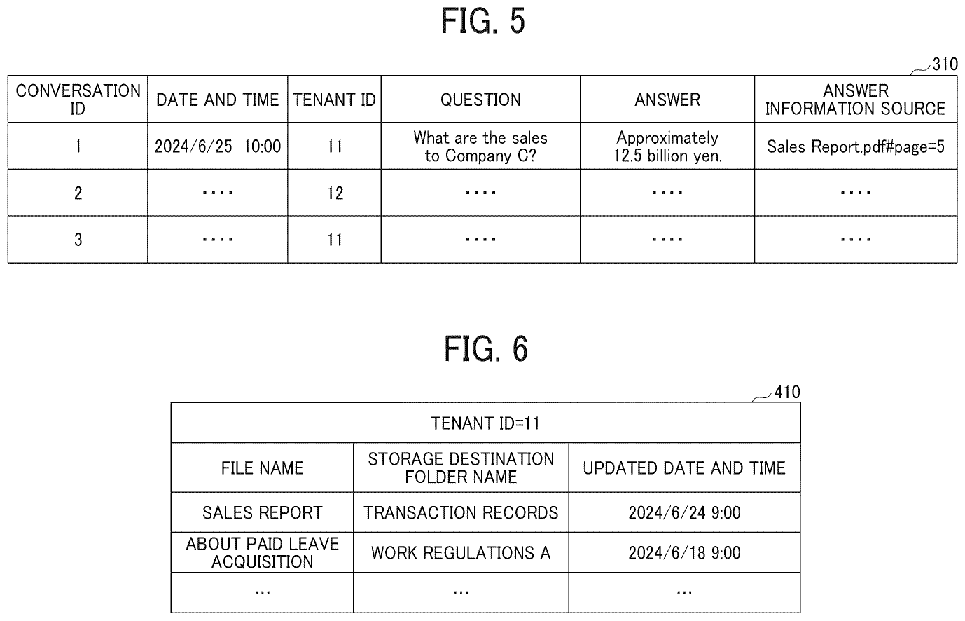

The DBs in the first storage device 300 and the second storage device 400 are described below with reference to FIGS. 5 to 8 before the description of the functional units of the information processing apparatus 200.

FIG. 5 is a diagram illustrating an example of the conversation history DB 310 included in the first storage device 300. The conversation history information stored in the conversation history DB 310 illustrated in FIG. 5 includes data items associated with one another, such as a conversation ID, a date and time, a tenant ID, a question, an answer, and an information source for the answer (answer information source).

The item “CONVERSATION ID” has a value that is an identifier for identifying a conversation. The conversation includes a set of question and answer. The item “DATE AND TIME” has a value indicating a date and time when input question data is input to the terminal apparatus 600 or a date and time when output answer data is output to the terminal apparatus 600. The item “TENANT ID” has a value that is an identifier for identifying a tenant to which the user operating the terminal apparatus 600 belongs. The terminal apparatus 600 is a particular terminal apparatus that has received a question input by the user.

The item “QUESTION” has a value indicating data (question data) input to the terminal apparatus 600, and is expressed as a sentence including a question. The item “ANSWER” has a value indicating data (answer data) output to the terminal apparatus 600, and is expressed as a sentence including an answer.

In the following description, data output to the terminal apparatus 600 as an answer is referred to as output answer data. In other words, the conversation history information includes one or more pieces of conversation history information (one or more conversation history records) each related to a conversation including a set of question and answer. Specifically, the conversation history information (each conversation history record) includes the conversation ID for identifying the conversation history information (conversation history record), the tenant ID of the tenant to which the user of the terminal apparatus 600 belongs, the date and time when the question data is input or the date and time when the output answer data is output, the question data, and the output answer data.

The item “ANSWER INFORMATION SOURCE” has a value indicating an information source for answer data. Specifically, for example, the value of the item “ANSWER INFORMATION SOURCE” is information for identifying internal information used as the information source for the output answer data. The information for identifying internal information may be a link indicating the storage location of the internal information.

FIG. 6 is a diagram illustrating an example of the document DB 410 included in the second storage device 400. The document DB 410 may store and manage internal information for each tenant.

The document DB 410 may be divided into multiple storage areas according to the types of internal information to be stored. In other words, the document DB 410 may have multiple folders created according to the types of files.

In the document DB 410, for example, the file name of internal information to be stored, the folder name in which the internal information is stored, the updated date and time of the internal information, may be stored in association with the internal information.

In the example of FIG. 6, internal information having the file name “SALES REPORT” is stored in a folder having the folder name “TRANSACTION RECORDS” at 9:00 on Jun. 24, 2024. Further, in the example of FIG. 6, internal information having the file name “ABOUT PAID LEAVE ACQUISITION” is stored in a folder having the folder name “WORK REGULATIONS A” at 9:00 on Jun. 18, 2024.

In the present embodiment, the folder in which internal information is to be stored is created according to the type of internal information. However, the way to create a folder is not limited thereto. The folder created in the document DB 410 may be created, for example, for each business activity in the tenant or for each department in the tenant. The folder in the document DB 410 can be configured by the administrator of the tenant that uses the chat system 100.

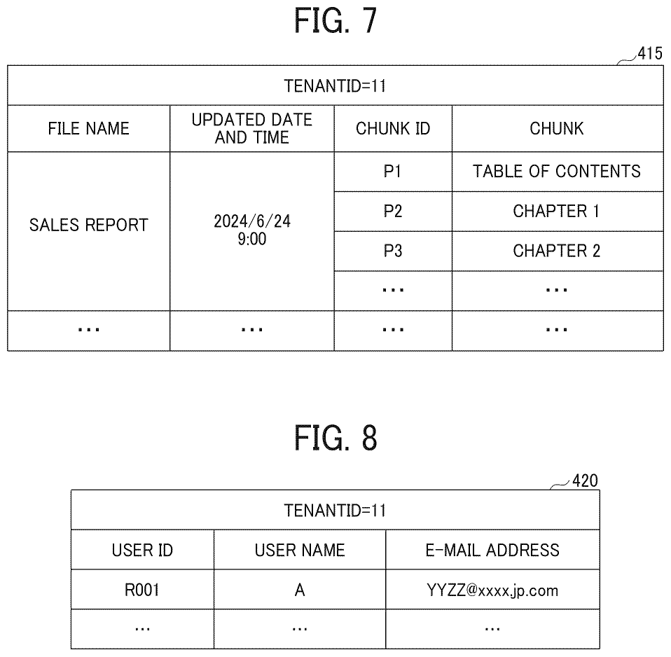

FIG. 7 is a diagram illustrating an example of the chunk DB 415 included in the second storage device 400. The table illustrated in FIG. 7 includes data items associated with one another, such as a file name of internal information, which is an example of information identifying the internal information, an updated date and time of the internal information, multiple chunk IDs for identifying chunks, and corresponding chunks.

In the example of FIG. 7, one page of the internal information contained in the internal document “SALES REPORT” is set as a chunk, and a page number is set as a chunk ID for identifying the chunk.

The chunk does not have to correspond to one page of the internal document, and may correspond to, for example, one paragraph or one chapter of the internal document.

FIG. 8 is a diagram illustrating an example of the user information DB 420 included in the second storage device 400. The user information stored in the user information DB 420 may be managed for each tenant.

The user information includes data items, such as a tenant ID, a user ID, a username, and an e-mail address. The item “TENANT ID” has a value, which is an identifier for identifying a tenant to which the user operating the terminal apparatus 600 belongs. The terminal apparatus 600 is a particular terminal apparatus that has received a question input by the user. The item “USER ID” has a value, which is an identifier for identifying a user operating the terminal apparatus 600. The item “USERNAME” has a value indicating the name of the user identified with the user ID. The item “E-MAIL ADDRESS” has a value indicating an e-mail address of the user identified with the user ID.

The second storage device 400 includes the user information DB 420. Alternatively, the second storage device 400 may not include the user information DB 420, but the document DB 410 and the chunk DB 415.

Returning to FIG. 4, the functional configuration of the information processing apparatus 200 is described below.

The information processing apparatus 200 includes an input reception unit 251, a search request unit 252, a conversation history acquisition unit 253, an information acquisition unit 254, a prompt generation unit 255, a prompt output unit 256, an analysis instruction unit 257, an analysis result holding unit 258, embedding unit 259, a segmentation unit 260, and an information output unit 261. These functional units are implemented by the CPU 201 of the information processing apparatus 200 reading out and executing instructions included in one or more programs installed in, for example, the HD 204.

The input reception unit 251 receives various inputs to the information processing apparatus 200. Specifically, the input reception unit 251 receives inputs of question data from the terminal apparatus 600. The input reception unit 251 also receives an instruction from the terminal apparatus 700 to store internal information in the second storage device 400.

The search request unit 252 requests the first storage device 300 or the second storage device 400 to conduct search. Specifically, the search request unit 252 transmits, to the first storage device 300, a search request to search the conversation history DB 310 using the question data as a search key. The search request unit 252 transmits, to the second storage device 400, a search request to search the chunk DB 415 based on a query generated by the server 500.

The conversation history acquisition unit 253 obtains conversation history information from the first storage device 300. The conversation history information is a search result obtained by searching the conversation history DB 310 according to the search request from the search request unit 252.

The information acquisition unit 254 obtains a chunk from the second storage device 400. The chunk is a search result retrieved by searching the chunk DB 415 according to the search request from the search request unit 252.

The prompt generation unit 255 generates a prompt to be output to the server 500. For example, when information to be included in the prompt is obtained, the prompt generation unit 255 generates a prompt including the obtained information in a predetermined format.

Specifically, the prompt generation unit 255 generates a prompt requesting creation of a search query for searching the chunk DB 415 of the second storage device 400. The prompt generation unit 255 also generates a prompt requesting to generate an answer to the question. The prompt generation unit 255 generates a prompt requesting a textual description (textual (linguistic) representation) of an object obtained by the analysis server 550 by analyzing the internal information.

The prompt output unit 256 outputs the prompt generated by the prompt generation unit 255 to the server 500.

The analysis instruction unit 237 requests the analysis server 550 to analyze the internal information requested to be stored in the second storage device 400. The analysis result holding unit 258 holds an analysis result obtained from the analysis server 550. The analysis result to be held may be image data indicating an image of an object included in the internal information and image data indicating an image of a heading of the object.

The embedding unit 259 embeds text data that represents a textual description of an image of an object obtained by the large-scale language model 511 at the position where the object is originally located in the internal information. The segmentation unit 260 divides the internal information in which the text data, which represents a textual description of the image of the object, is embedded at the position where the object is located into multiple chunks.

The information output unit 261 outputs various types of information to the outside of the information processing apparatus 200. Specifically, for example, the information output unit 261 outputs answer data to a question to the terminal apparatus 600. The information output unit 261 also outputs conversation history information to the first storage device 300. The information output unit 261 outputs, to the second storage device 400, the multiple chunks of internal information in which data that represents a textual description of an object has been embedded in place of the object.

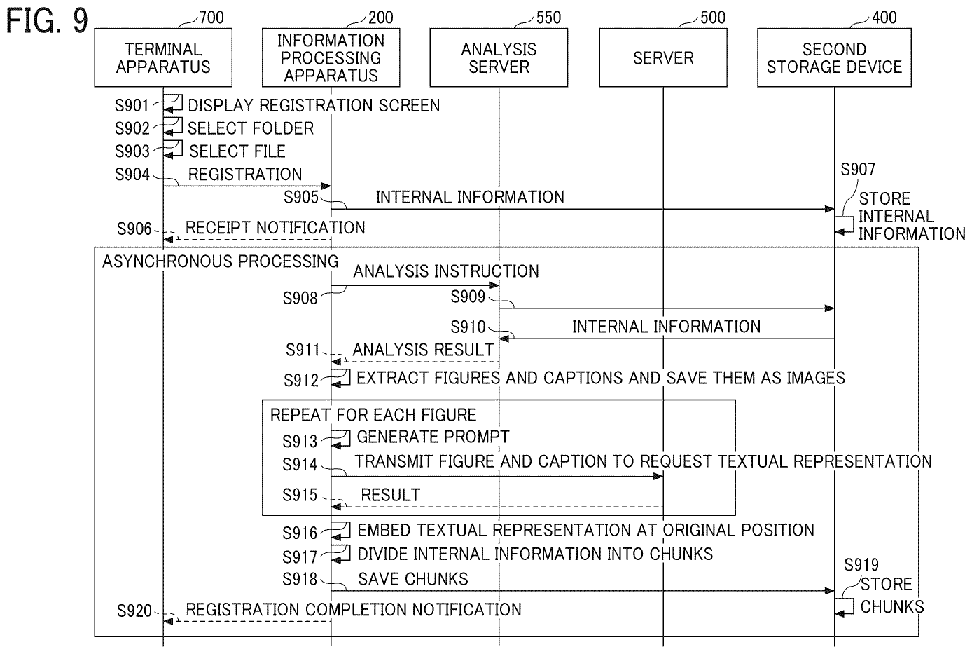

An example operation of the chat system 100 is described below. An example operation of the chat system 100 when an instruction to store internal information is received from the terminal apparatus 700 is described below with reference to FIG. 9.

FIG. 9 is a first sequence diagram illustrating an operation performed by the chat system 100 according to the first embodiment.

In step S901, in the chat system 100, the display control unit 750 of the terminal apparatus 700 displays a registration screen for registering internal information. In step S902, the input reception unit 740 of the terminal apparatus 700 selects a folder as a storage destination of internal information. In step S903, the input reception unit 740 of the terminal apparatus 700 receives a selection of internal information to be stored in the folder. In step S904, the communication control unit 730 of the terminal apparatus 700 transmits (uploads) the selected internal information to the information processing apparatus 200.

When the input reception unit 251 receives the internal information, in step S905, the information output unit 261 of the information processing apparatus 200 transmits the received internal information to the second storage device 400. In step S906, the information output unit 261 transmits to the terminal apparatus 700 a receipt notification indicating that the internal information has been received. That is, the input reception unit 251 is an example of a receiving unit that receives a registration request to store a file in the storage unit. In step S907, the storage unit 440 of the second storage device 400 stores the internal information in the selected folder in the document DB 410.

Subsequently, the information processing apparatus 200 performs processing for dividing the internal information stored in the document DB 410 of the second storage device 400 into chunks. The subsequent processing from step S908, as described below, may be performed at a timing independent of the processing from steps S901 to S907. In other words, the processing for dividing the internal information into chunks may be performed asynchronously relative to the processing for storing the internal information in the document DB 410.

In FIG. 9, the operation of the chat system 100 in a case where an object is included in the internal information stored in the document DB 410. In a case where an object is not included in the document DB 410, the information processing apparatus 200 may proceed to step S917 subsequent to step S907, as will be described later.

In step S908, the analysis instruction unit 237 of the information processing apparatus 200 transmits an analysis instruction for analyzing the internal information stored in the document DB 410. In steps S909 and S910, in response to receiving the analysis instruction, the analysis server 550 obtains the internal information stored in the document DB 410 from the second storage device 400.

In step S911, when the analysis server 550 obtains the internal information, the analysis server 550 analyzes the internal information and transmits the analysis result to the information processing apparatus 200. At this time, the analysis server 550 may transmit the internal information obtained from the second storage device 400 to the information processing apparatus 200 together with the analysis result.

In step S912, the analysis result holding unit 258 of the information acquisition unit 254 that has obtained the analysis result from the analysis server 550 holds the analysis result. The analysis result held by the analysis result holding unit 258 are the images of the objects and the images of the captions extracted from the internal information.

The information processing apparatus 200 performs the processing from step S913 to step S915 the same number of times as the number of objects included in the internal information.

In step S913, after the analysis result is held, the prompt generation unit 255 of the information processing apparatus 200 generates a prompt including an image of the object and an image of the caption and requesting a textual description of the image of the object. In other words, the prompt generation unit 255 generates a prompt to output content that can be derived from the object included in the file for which the registration request has been accepted.

In step S914, the prompt output unit 256 of the information processing apparatus 200 transmits the generated prompt to the server 500. The prompt transmitted to the server 500 will be described in detail later.

In step S915, the information acquisition unit 254 of the information processing apparatus 200 obtains text data resulting from the use of the large-scale language model 511 to generate a textual description of the object, from the server 500.

In step S916, subsequently, the embedding unit 259 of the information processing apparatus 200 embeds the text data obtained in step S915 at the position where the object is originally located in the internal information, which is subjected to the analysis. With this internal information, the internal information that originally includes an object other than text data becomes the internal information including only text data.

In step S917, subsequently, the segmentation unit 260 of the information processing apparatus 200 divides the internal information that is text data into chunks. In step S918, the information output unit 261 of the information processing apparatus 200 transmits the divided chunks to the second storage device 400. That is, the information output unit 261 functions as a registration unit that registers text data generated as a textual description of an object (the result output by the large-scale language model 511) in a storage unit.

In step S919, the storage unit 440 of the second storage device 400 stores the chunks received from the information processing apparatus 200 in the chunk DB 415 together with the information for identifying the internal information that includes the chunks. As a result, all chunks stored in the chunk DB 415 are text data.

In step S920, the information output unit 261 of the information processing apparatus 200 transmits a completion notification indicating that the registration of the internal information has been completed to the terminal apparatus 700.

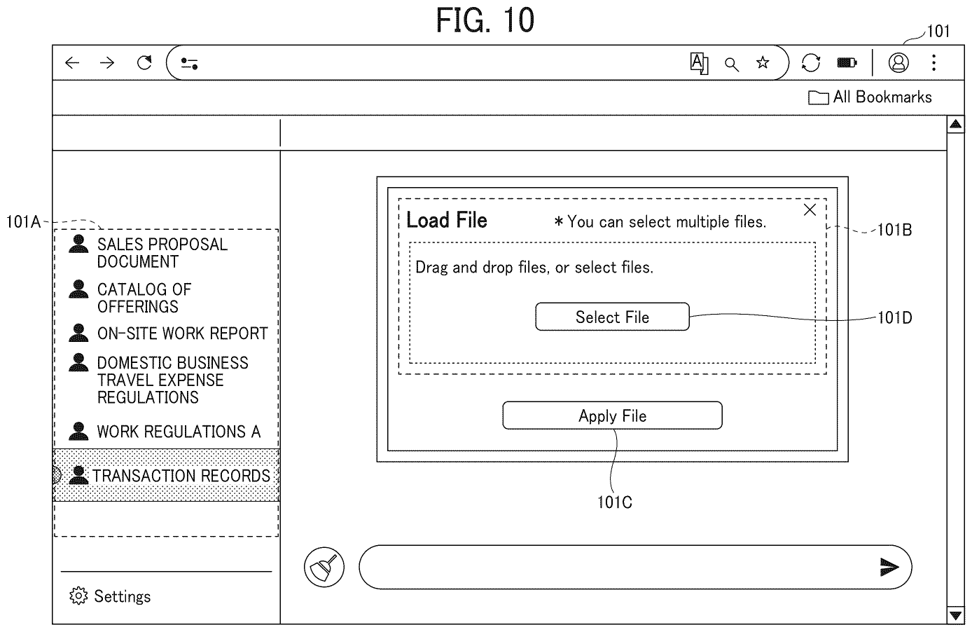

The operation illustrated in FIG. 9 will be described in detail with reference to FIGS. 10 to 15. FIG. 10 is a diagram illustrating an example of an internal information registration screen according to the first embodiment. A screen 101 illustrated in FIG. 10 is an example of the registration screen displayed on the terminal apparatus 700 in step S507 of FIG. 9.

The screen 101 includes display areas 101A and 101B and an operation button 101C. In the display area 101A, a list of folders created in the document DB 410 is displayed.

In other words, a list of folder names of folders created in the document DB 410 is displayed in the display area 101A.

A folder selected from the list of folders displayed in the display area 101A is a storage destination of internal information to be uploaded.

In the display area 101B, a message prompting a user to select internal information to be uploaded and an operation button 101D for selecting internal information to be uploaded are displayed.

The operation button 101C is an operation button for uploading the internal information selected in the display area 101B.

In the example of FIG. 10, since the folder name “TRANSACTION RECORDS” is selected in the display area 101A, the storage destination of the internal information to be uploaded is the transaction record folder.

When the operation button 101D is selected in the display area 101B, a list of internal information managed by the terminal apparatus 700 is displayed, and when the operation button 101C is operated after internal information is specified, the specified internal information is transmitted to the second storage device 400 via the information processing apparatus 200. The specified internal information is stored in the “TRANSACTION RECORDS” folder created in the document DB 410 of the second storage device 400.

As described above, in the present embodiment, when internal information is stored in the second storage device 400, a folder to be a storage destination of the internal information can be selected.

In the present embodiment, when a predetermined operation is performed on the screen 101, a new folder may be created in the document DB 410 of the second storage device 400.

That is, the folders in the document DB 410 may be edited by, for example, the administrator of the chat system 100.

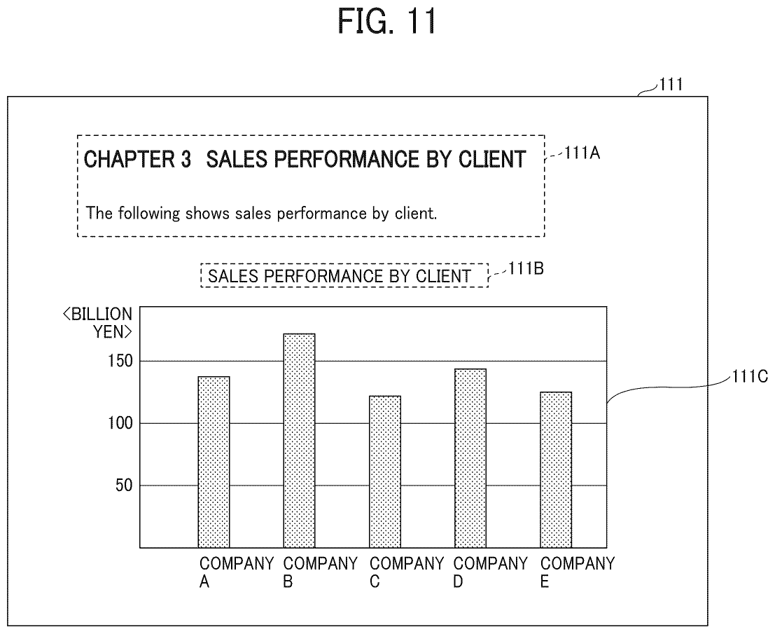

FIG. 11 is a diagram illustrating an example of internal information according to the first embodiment. A case where internal information 111 illustrated in FIG. 11 is uploaded to the chat system 100 is described below.

The internal information 111 illustrated in FIG. 11 is described as, for example, the fifth page of a file “sales report. pdf”.

The internal information 111 illustrated in FIG. 11 includes text data 111A, a heading 111B for a bar graph 111C, and the bar graph 111C. The heading 111B and the bar graph 111C are data other than text data. In other words, the internal information 111 includes two objects.

When the analysis server 550 receives an analysis instruction to analyze the internal information 111 from the information processing apparatus 200, the analysis server 550 analyzes the internal information 111 and transmits the analysis result to the information processing apparatus 200.

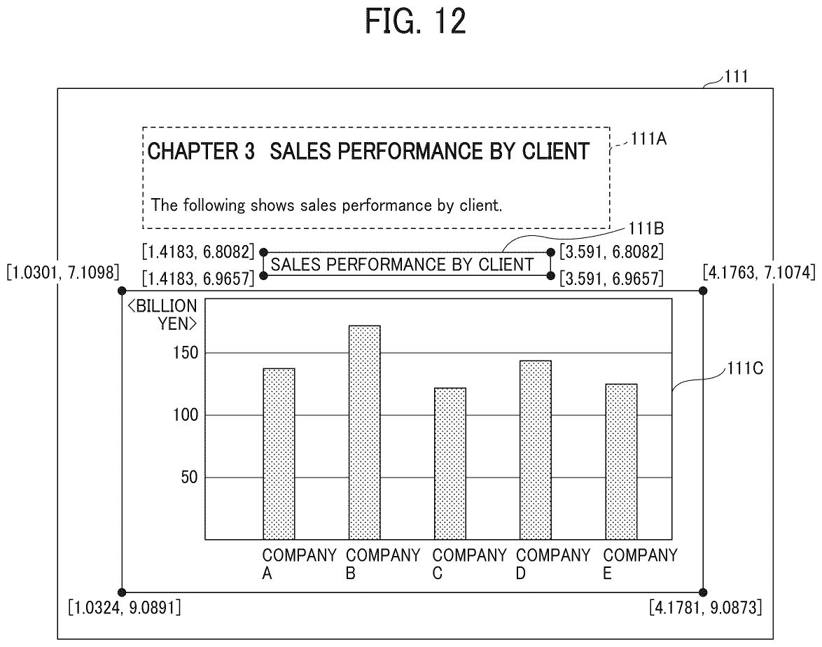

FIG. 12 is a diagram illustrating an analysis result obtained by analyzing internal information by the analysis server. When the analysis server 550 that has received an analysis instruction to analyze the internal information 111 including an object recognizes a rectangle containing the heading 111B and a rectangle containing the bar graph 111C in the internal information 111 and extracts the rectangles including the heading 111B and the bar graph 111C as images. In other words, the analysis server 550 recognizes a bounding rectangle of the object and extracts the bounding rectangle as an image.

The analysis server 550 extracts coordinates of four points for each of the rectangle including the heading 111B and the rectangle including the bar graph 111C. The coordinates may be based on the origin at the top-left corner of the screen where the internal information 111 is displayed.

The analysis server 550 transmits to the information processing apparatus 200 image data representing the image of the heading 111B, image data representing the image of the bar graph 111C, and the coordinates of the four points of the rectangle including the heading 111B and bar graph 111C as the analysis result.

The method for extracting an image of an object in the analysis server 550 is not limited to the above-described example. The analysis result may not need to include the coordinates of the four points of the rectangle. It is sufficient if the analysis result includes image data representing the image of the object included in the internal information 111.

When the information processing apparatus 200 obtains the analysis result from the analysis server 550, the prompt generation unit 255 generates a prompt requesting a textual description (textual representation) of the object and transmits the prompt to the server 500. The prompts generated by the prompt generation unit 255 is described below.

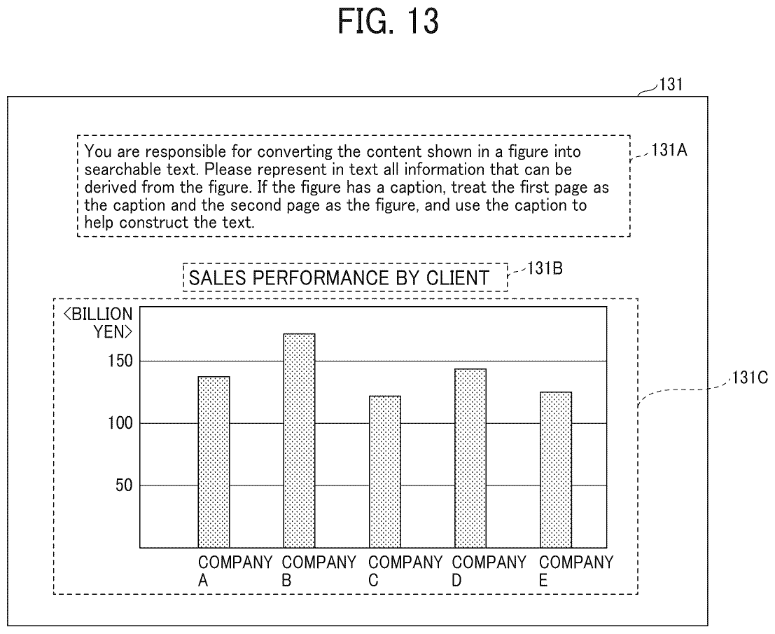

FIG. 13 is a diagram illustrating an example prompt. A prompt 131 illustrated in FIG. 13 is an example of the prompt generated in step S913 of FIG. 9.

The prompt 131 includes text data 131A, an image 131B corresponding to the heading 111B, and an image 131C corresponding to the bar graph 111C. The images 131B and 131C are obtained as the analysis result by the analysis server 550.

The text data 131A includes a message that requests the large-scale language model 511 to represent the images included in the prompt as searchable text, as well as a message that requests to represent the details that can be derived from the images as text. In other words, the text data 131A includes a message for outputting the content that can be derived from the object included in the file as a textual description. “Converting into text” means representing the content as text data.

In the example of FIG. 13, the text data 131A include content that requests to represent the details that can be derived from the images 131B and 131C as text data.

The information processing apparatus 200 transmits the prompt 131 to the server 500. The server 500 inputs the prompt 131 to the large-scale language model 511 and transmits to the information processing apparatus 200 text data output by the large-scale language model 511 as a response to the prompt 131. The text data output from the large-scale language model 511 as a response to the prompt 131 represents content of the images 131B and 131C as textual descriptions.

In the example of FIG. 13, the prompt 131 includes an image as an example of an object and a message for outputting content that can be derived from the object, but is not limited thereto.

The prompt generated in step S913 of FIG. 9 may include the text data 131A without objects. In this case, the information output unit 261 of the information processing apparatus 200 may transmit the object to the server 500 along with the prompt generated in step S913. That is, the information output unit 261 also functions as a transmission unit that transmits the prompt generated by the prompt generation unit 255 and the object included in the file to the large-scale language model 511.

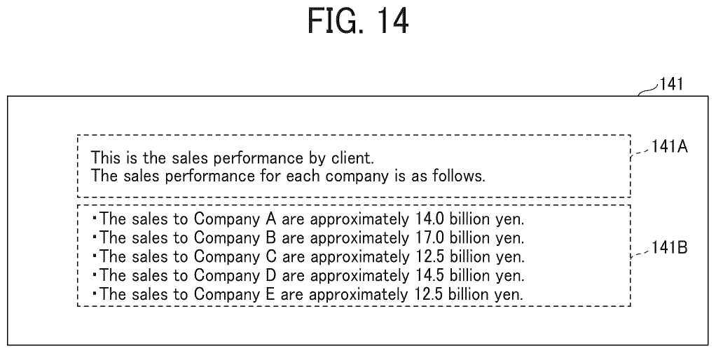

FIG. 14 is a diagram illustrating an example of a result that is a textual description of the object obtained by a large-scale language model according to the first embodiment. Text data 141 illustrated in FIG. 14 is an example of a result that is a textual description of the bar graph 111C, obtained by the large-scale language model 511. The text data 141 is received by the information processing apparatus 200 from the server 500 in step S915 of FIG. 9.

The text data 141 includes text data 141A and text data 141B. The text data 141A represents a textual description of details that can be derived from the image of the heading 111B. The text data 141B represents a textual description of details that can be derived from the image of the bar graph 111C.

In the embodiment described above, by inputting a prompt that includes an image of an object included in internal information and requests a textual description of the image of the object to the large-scale language model 511, text data that represents a textual description of the image of the object can be obtained.

The information processing apparatus 200 of this embodiment acquires the text data 141 and replaces this text data 141 with the heading 111B and the bar graph 111C in the internal information 111 that is the original information.

In other words, the embedding unit 259 of the information processing apparatus 200 removes the heading 111B from the internal information 111 and embeds the text data 141A at the position where the heading 111B was located. Further, the embedding unit 259 removes the bar graph 111C from the internal information 111 and embeds the text data 141B at the position where the bar graph 111C was located.

In the present embodiment, the internal information including the object is replaced with the internal information represented as a textual description (internal information as a textual representation) by the processing of the embedding unit 259. In the following description, replacing an object included in internal information with text data obtained by the large-scale language model 511 may be referred to as representing internal information as textual descriptions (converting internal information into a textual representation).

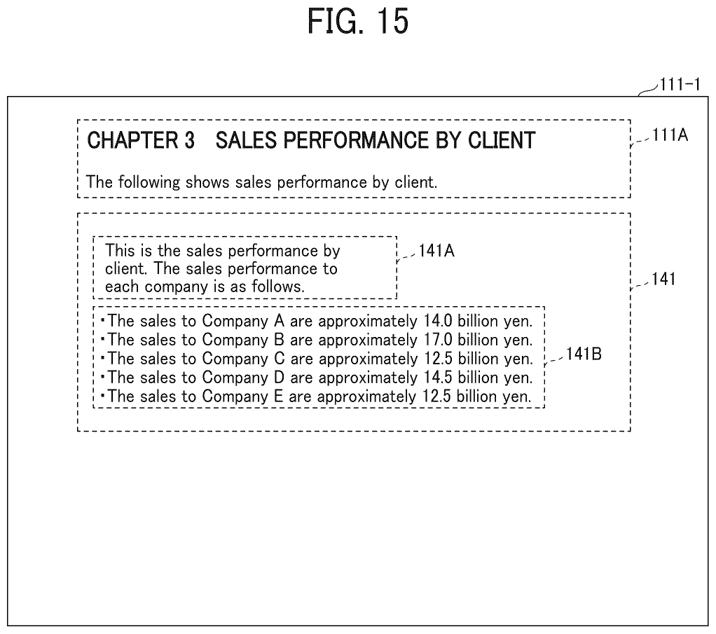

FIG. 15 is a diagram illustrating an example of internal information as a textual representation. Internal information 111-1 illustrated in FIG. 15 is obtained by representing the internal information 111 illustrated in FIG. 11 as a textual description in step S916 of FIG. 9. In other words, the internal information 111-1 is obtained by converting the internal information 111 into a textual representation.

The internal information 111-1 includes text data 141A placed at the position where the heading 111B is located in the internal information 111, and text data 141B is originally placed at the position where the bar graph 111C is originally located.

In the embodiment described above, when an object is included in internal information, the internal information is represented as a textual description (the internal information is converted into a textual representation) by replacing the object with text data. In this embodiment, the internal information represented as textual description (the internal information as a textual representation) is divided into chunks, and each chunk is stored in the chunk DB 415 of the second storage device 400.

Accordingly, in this embodiment, the internal information including an object can be used as an information source in generating answer data by the large-scale language model 511, thereby increasing the accuracy of the answer to the question.

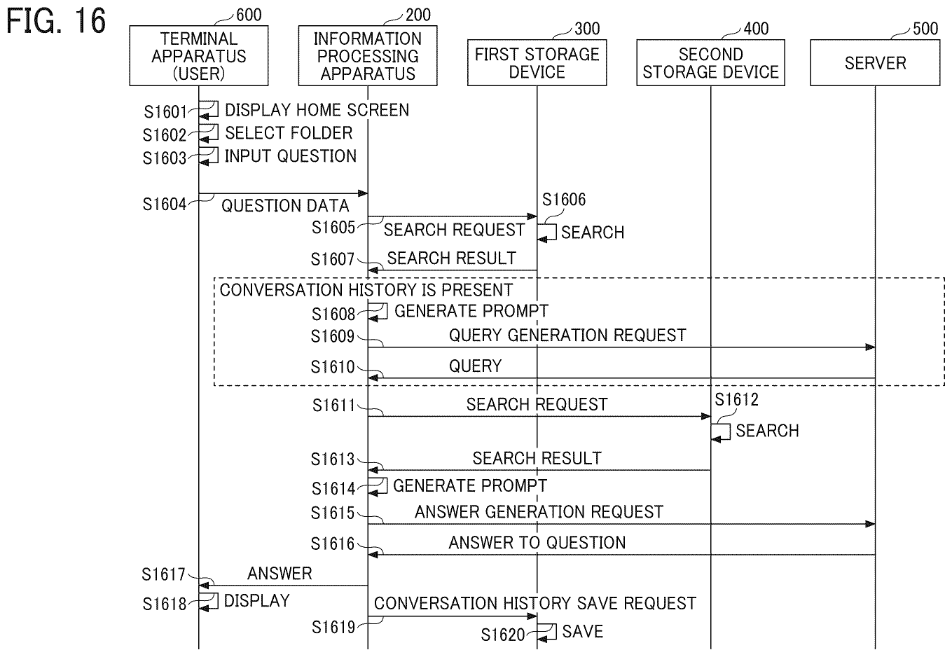

An example operation of the chat system 100 when question data is input from the terminal apparatus 600 to the chat system 100 is described below with reference to FIG. 16.

In the chat system 100, when question data is input from the terminal apparatus 600, answer data using a chunk stored in the chunk DB 415 as an information source is output in response to the input question data. FIG. 16 is a second sequence diagram illustrating an operation performed by the chat system 100 according to the first embodiment.

In step S1601, in the chat system 100, the terminal apparatus 600 displays the home screen of the chat system 100. In step S1602, the input reception unit 640 of the terminal apparatus 600 receives a selection of a folder that stores internal information related to question data.

In step S1603, the input reception unit 640 of the terminal apparatus 600 receives input of the question data. In step S1604, the communication control unit 630 of the terminal apparatus 600 transmits the input question data to the information processing apparatus 200. The question data to be transmitted may be assigned with a tenant ID identifying a tenant to which the user operating the terminal apparatus 600 belongs.

In step S1605, in response to receiving the question data by the input reception unit 251, the search request unit 252 of the information processing apparatus 200 transmits a search request including the tenant ID to the first storage device 300.

In step S1606, in response to receiving the search request, the search unit 330 of the first storage device 300 searches the conversation history DB 310.

The process performed by the search unit 330 is described below. The search unit 330 identifies conversation history information including the tenant ID, which is obtained from the search request, from among the conversation history information stored in the conversation history DB 310. The search unit 330 acquires, from among the identified conversation history information, conversation history information having a content related to the question represented by the question data, as a search result.

Specifically, the search unit 330 acquires conversation history information for the conversations that have continued until immediately before the question is input in step S1603, from the identified conversation history information including the tenant ID of the search request.

The conversation history information corresponding to the conversations that have continued until immediately before the question data is input in step S1603 refers to conversation history information that has been stored within a certain period of time between the time when the question data is input and the time when the output answer data is last output before the input of the question data. In the present embodiment, when next question data is input within a certain period time after the output answer data is output, the series of questions and answers within the certain period time are regarded as responses relating to the same inquiry.

As described above, the chat system 100 acquires the conversation history information having a content related to the question represented by the question data.

In step S1607, the search unit 330 of the first storage device 300 searches the conversation history DB 310 to retrieve a search result, and transmits the search result to the information processing apparatus 200. The conversation history acquisition unit 253 of the information processing apparatus 200 obtains the search result, which is the conversation history information.

When the conversation history information is obtained from the first storage device 300 as the search result, the information processing apparatus 200 performs steps S1608 to S1610.

The case where the conversation history information is obtained as the search result refers to a case where, before the question data input in step S1603 is input, other question data relating to the question represented by the question data input in step S1603 is input and output answer data corresponding to the other question data is output. In such as a case, the conversation history information including the input question data and the output answer data is stored in the conversation history DB 310.

In the case where the conversation history information is not acquired from the first storage device 300 as the search result, the operation proceeds to step S1611 without performing steps S1608 to S1610. The case where the conversation history information is not obtained as the search result refers to a case where the question data input in step S1603 is the first question in the inquiry.

In step S1608, the prompt generation unit 255 of the information processing apparatus 200 generates a prompt requesting to generate a query for searching the document DB 410. At this time, the prompt generation unit 255 generates a prompt requesting to generate a query based on the question data input in step S11603 and the conversation history information obtained by the conversation history acquisition unit 253.

In step S1609, the prompt output unit 256 of the information processing apparatus 200 transmits the prompt requesting to generate a query to the server 500.

The input unit 520 of the server 500 inputs the prompt to the large-scale language model 511, and in step S1610, the output unit 530 transmits to the information processing apparatus 200 output data output from the large-scale language model 511 as a query.

In step S1611, the search request unit 252 of the information processing apparatus 200 transmits to the second storage device 400 a search request to search the chunk DB 415 for a chunk that can be an information source in generating answer data to the question data.

Specifically, when the query is acquired in step S1610, the search request unit 252 transmits to the second storage device 400 the search request using the query as a search key. When the query is not acquired, that is, when the conversation history information is not acquired in step S16074, the search request unit 252 transmits the search request including the question data input in step S1603 to the second storage device 400.

In response to receiving the search request, the search unit 430 of the second storage device 400 searches the chunk DB 415 in step S1612 and transmits a chunk obtained as a search result to the information processing apparatus 200 in step S1613.

In step S1614, in response to obtaining the chunk that is the search result by the information acquisition unit 254, the prompt generation unit 255 of the information processing apparatus 200 generates a prompt requesting to generate answer data to the question data using the chunk as an information source, and in step S1615, transmits the prompt to the server 500.

In response to receiving the prompt, the input unit 520 of the server 500 inputs the prompt to the large-scale language model 511, and in step S1616, the output unit 530 transmits to the information processing apparatus 200 output data output from the large-scale language model 511 as output answer data.

In step S1617, the information output unit 261 of the information processing apparatus that has obtained the output answer data outputs the obtained output answer data to the terminal apparatus 600. In step S1618, the display control unit 650 of the terminal apparatus 600 displays the output answer data on the display 618. Specifically, the display control unit 650 displays the output answer data on the display 618 in association with the question data.

In step S1619, the information output unit 261 of the information processing apparatus 200 transmits to the first storage device 300 a request to store the conversation history information that includes the question data received in step S1603 and the output answer data output to the terminal apparatus 600 in step S1616. The request to store the conversation history information includes the tenant ID of the tenant to which the user of the terminal apparatus 600 belongs.

In step S1620, the storage unit 340 of the first storage device 300 stores the conversation history information as a new record of the conversation history DB 310. Specifically, the storage unit 340 assigns a new conversation ID and a new date and time, each to the question data, the output answer data, and the tenant ID, which are acquired from the information processing apparatus 200, and stores these data items in the conversation history DB 310 as the conversation history information. In this way, the contents of the conversation history DB 310 are updated.

In the following description, the operation of the chat system 100 described in FIG. 16 may be referred to as a question answering process. A question answering sequence refers to the processing from step S1601 to step S1620 performed by the chat system 100 in FIG. 16.

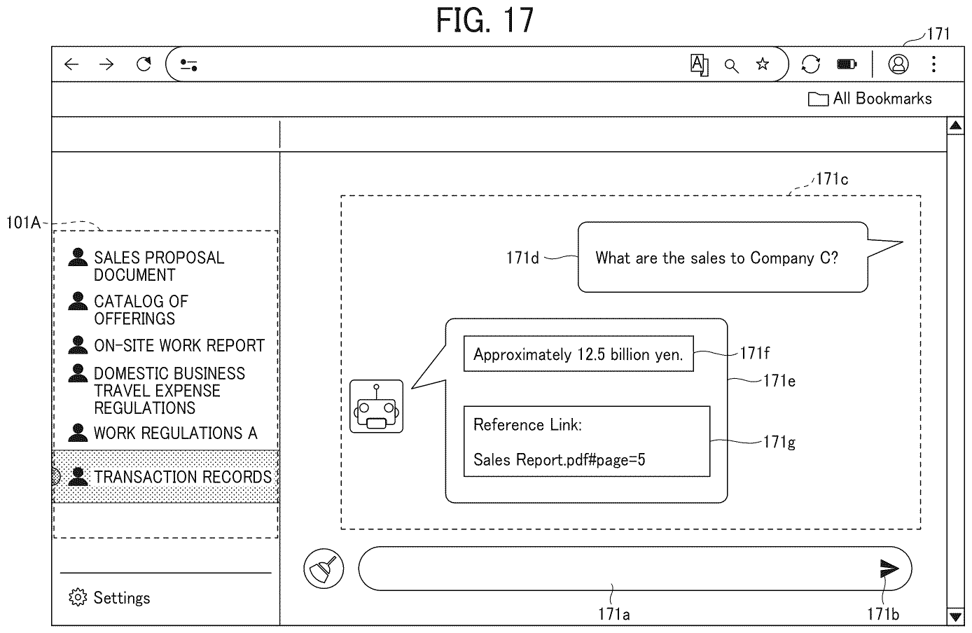

In the following description, an example of the display when the question data is input on the home screen displayed on the terminal apparatus 600 is described with reference to FIG. 17. FIG. 17 is a diagram illustrating a display example when question data is input to the terminal apparatus 600 according to the first embodiment.

A screen 171 illustrated in FIG. 17 is an example of the screen displayed on the terminal apparatus 600 in step S1618 of FIG. 16.

The screen 171 includes a display area 101A, an input field 171a, an operation button 171b, and a display area 171c. In the display area 101A, a list of folders provided in the document DB 410 of the second storage device 400 is displayed.

The input field 171a is an input field for the user of the terminal apparatus 600 to input a question. The operation button 171b is an operation button for transmitting the question data that represents the question entered in the input field 171a to the information processing apparatus 200.

In the display area 171c, the question data representing the question input by the user of the terminal apparatus 600 in the input field 171a and the answer data generated by the large-scale language model 511 in response to the question are displayed. In other words, the display area 171c displays details of the conversation between the user of the terminal apparatus 600 and the chat system 100.

The screen 171 illustrated in FIG. 17 is displayed on the terminal apparatus 600 after the terminal apparatus 600 receives response data representing an answer to the question after receiving a selection of a folder in the display area 101A, a question via the input field 171a, and an operation on the operation button 71b.

In this embodiment, the user of the terminal apparatus 600 can obtain an answer based on internal information stored in a folder by selecting the folder that seems to include internal information related to a question when inputting the question.

The selection of a folder performed by the user of the terminal apparatus 600 allows the search unit 430 to search only the chunks of the internal information stored in the selected folder, in step S1612 of FIG. 6, thereby reducing the load of the search processing.

In the example of FIG. 17, the display area 171c includes display areas 171d and 171e. In the display area 171d, the question data representing the question input by the user of the terminal apparatus 600 is displayed.

In the display area 171d, the answer data representing the answer to the question is displayed.

Further, the display area 171 e includes display areas 171 f and 171g. In the display area 171f, the answer data representing the answer to the question is displayed, and in the display area 171g, information for identifying the internal information used as an information source for the answer (answer information source) is displayed. The information for identifying the internal information may be the name of the internal information and a link indicating the storage location of the internal information. In that case, information indicating the storage location of the internal information is the information indicating the storage location of the internal information in the document DB 410.

Further, the internal information that is an information source for the answer (answer information source) is information stored in the folder selected from the list of folders displayed in the display area 101A.

In the example of FIG. 17, the question displayed in the display area 171d is, “What are the sales to Company C?” The answer displayed in the display area 171f is “Approximately 12.5 billion yen.” and the information that identifies the internal information displayed in the display area 171g is a link that indicates the storage location of “Sales Report.pdf#page5”.

The information processing apparatus 200 may acquire the selected internal information by the information acquisition unit 254 when the link displayed in the display area 171g on the terminal apparatus 600 is selected, and the acquired internal information may be displayed on the terminal apparatus 600 by the information output unit 261.

In the present embodiment, “Sales Report.pdf#page5” is the internal information 111 illustrated in FIG. 11. Accordingly, when the link displayed in the display area 171g on the terminal apparatus 600 is selected, the information processing apparatus 200 acquires the internal information 111 to be displayed on the screen 171 from the document DB 410 of the second storage device 400 by the information acquisition unit 254. The internal information 111 to be displayed includes the heading 111B and the bar graph 111C that are objects.

That is, the answer data displayed in the display area 171g is information read from the objects included in the internal information 111.

As described above, in the present embodiment, an answer to a question can be generated using internal information that includes an object as an information source. Accordingly, according to the present embodiment, the user-specific information including an object can also be used as an information source to generate answers to questions using the large-scale language model 511, thereby increasing the accuracy of the answers to the questions.

### Second Embodiment

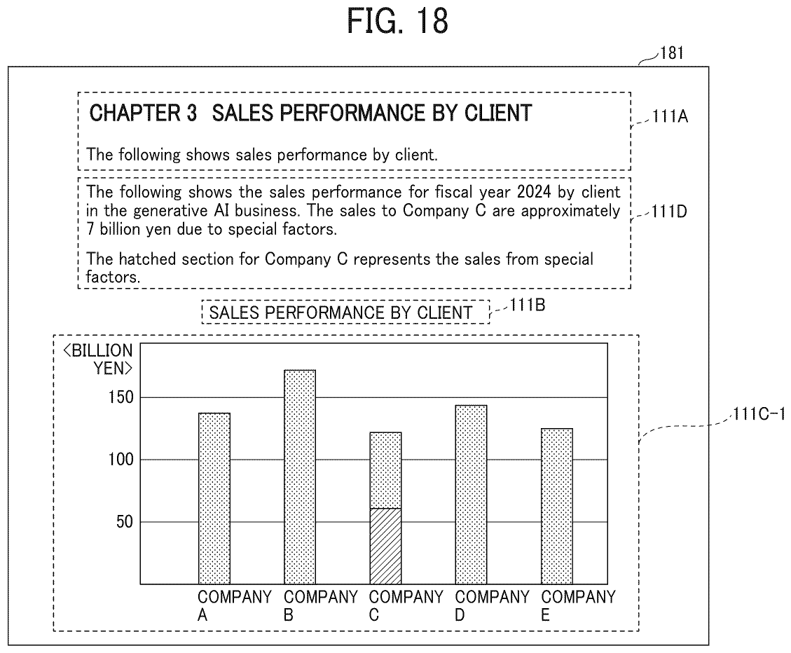

The chat system according to a second embodiment is described below with reference to FIGS. 18 to 21. The second embodiment is different from the first embodiment in that, when an object is included in internal information and supplementary information such as an explanatory text of the object is present, the supplementary information is also included in a prompt requesting a textual description (textual representation) of the object. In the following description of the second embodiment, differences from the first embodiment are described. The same reference numerals are given to the same or corresponding functions or configurations as those of the first embodiment, and redundant descriptions thereof are omitted or simplified appropriately.

FIG. 18 is a diagram illustrating an example of internal information according to the second embodiment. Internal information 181 illustrated in FIG. 18 is an example of internal information uploaded to the information processing apparatus 200 in step S904 of FIG. 9.

The internal information 181 includes the text data 111A, the heading 111B for a graph, and a bar graph 111C-1, which is one of the objects, as well as text data 111D that describes the content indicated by the bar graph 111C-1. The text data 111D is, in other words, supplementary information for the bar graph 111C-1.

In this embodiment, the prompt generation unit 255 of the information processing apparatus 200 generates a prompt requesting a textual description (textual representation) of the object such that the prompt includes the text data 111D. The prompt is to be input to the large-scale language model 511.

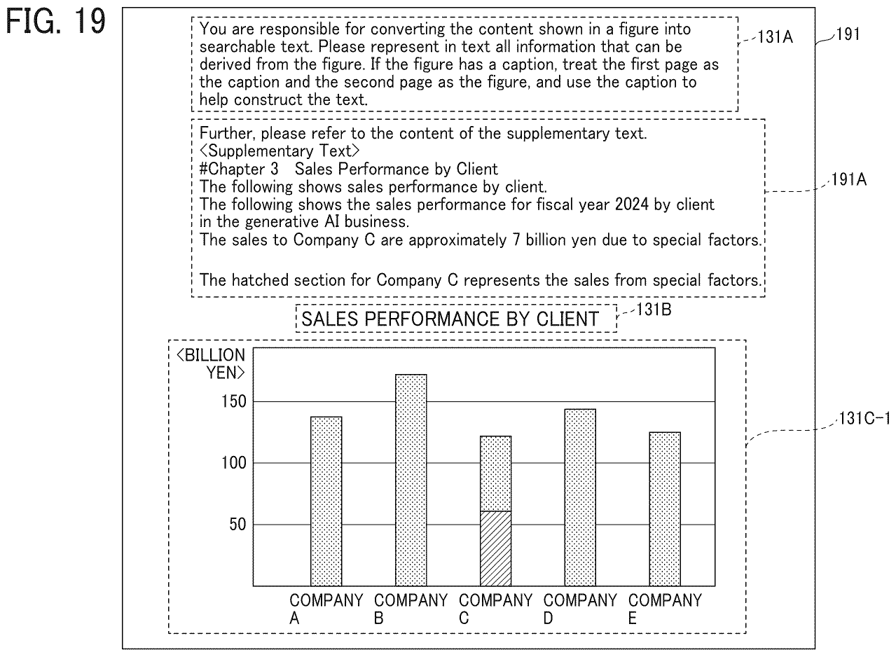

FIG. 19 is a diagram illustrating an example prompt. A prompt 191 illustrated in FIG. 19 is an example of the prompt generated in step S913 of FIG. 9.

The prompt 191 includes the text data 131A, the image 131B corresponding to the heading 111B, an image 131C-1 corresponding to the bar graph 111C-1, and text data 191A. The images 131B and 131C-1 are obtained as the analysis result by the analysis server 550.

The text data 191A is text data that requests to use the text data 111D included in the internal information 181 as a reference. In other words, the text data 191A is text data that requests reference to supplementary information that describes the content indicated by the bar graph 111C-1 in representing the object as a textual description.

In the present embodiment, by including the supplementary information for the object and the text data requesting reference to the supplementary information in the prompt requesting a textual description (textual representation) of the object for the large-scale language model 511, the large-scale language model 511 can provide a textual description of the object in more detail. As a result, according to the present embodiment, the accuracy of the answer to the question can be increased.

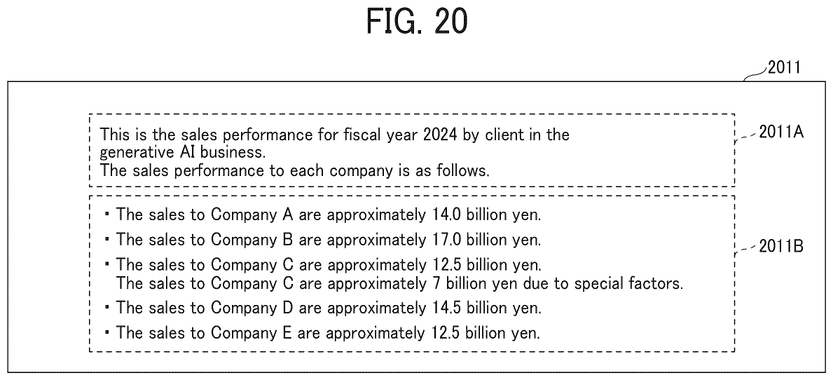

FIG. 20 is a diagram illustrating an example of a result that is a textual description of the object obtained by a large-scale language model according to the second embodiment. Text data 2011 illustrated in FIG. 20 is an example of a result that is a textual description of the bar graph 111C-1, obtained by the large-scale language model 511. The text data 2011 is received by the information processing apparatus 200 from the server 500 in step S915 of FIG. 9.

The text data 2011 includes text data 2011A and text data 2011B. The text data 2011A includes the textual description of details that can be derived from the image of the heading 111B, and a part of the text data 111D that is supplementary information related to the bar graph 111C-1. Specifically, the text data 2011A includes text stating “This is the sales performance for fiscal year 2024 by clients in the generative AI business.” that is part of the text data 111D.

The text data 2011B includes the textual description of details that can be derived from the image of the bar graph 111C-1, and a part of the text data 111D that is supplementary information related to the bar graph 111C-1. Specifically, the text data 2011B includes text stating “Company C has approximately 7 billion yen in sales due to special factors.” that is part of text data 111D.

As described above, in this embodiment, by inputting a prompt requesting a textual description (textual representation) of an object using supplementary information as a reference to the large-scale language model 511, text data that represents a textual description of the object in detail based on the supplementary information can be obtained.

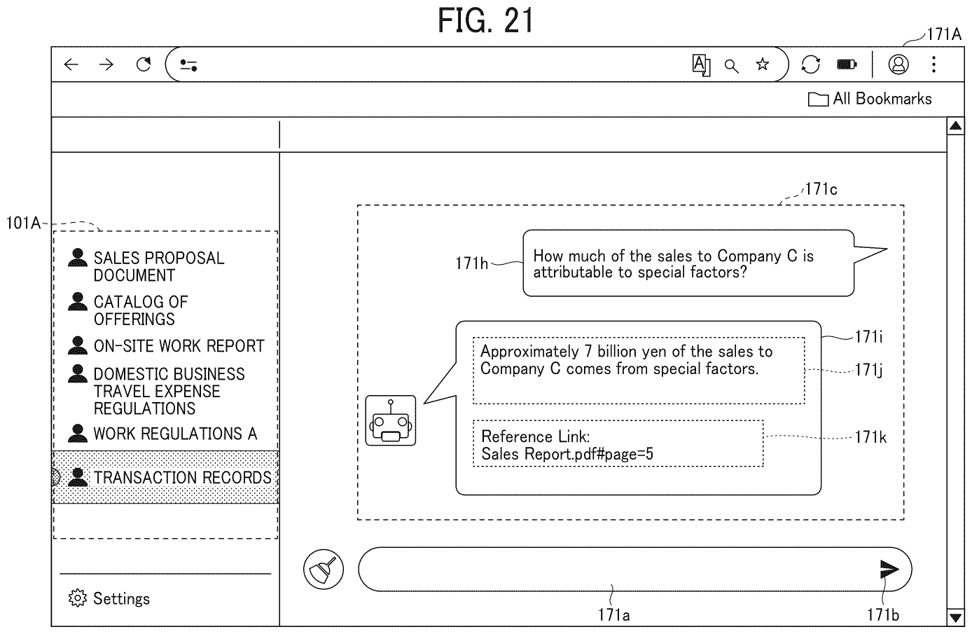

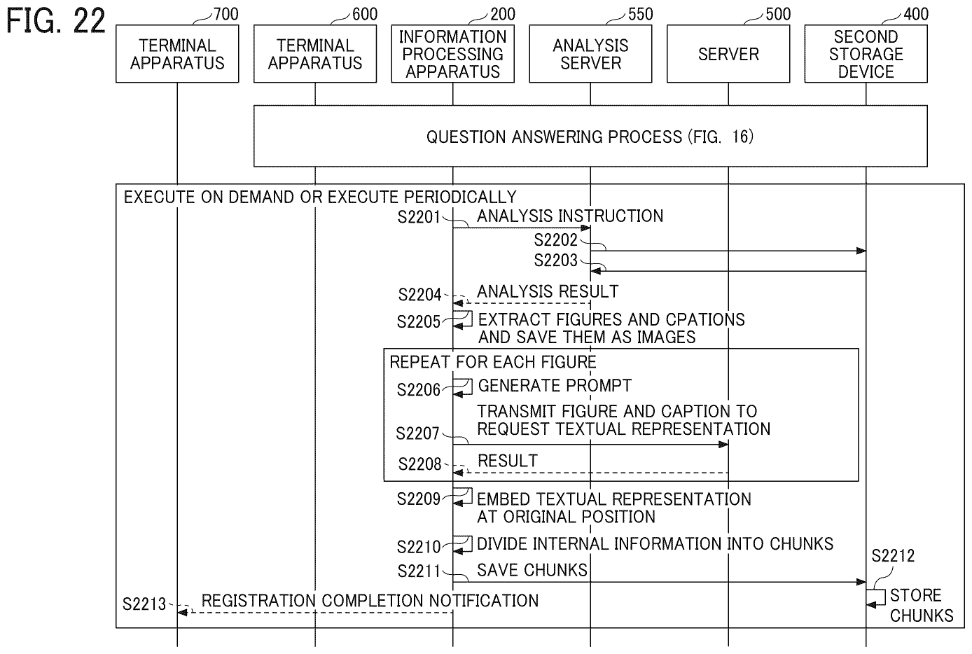

A display example displayed on the display of the terminal apparatus 600 is described below with reference to FIG. 21. FIG. 21 is a diagram illustrating an example screen displayed on the terminal apparatus 600.

A screen 171A illustrated in FIG. 21 is an example of the screen displayed on the terminal apparatus 600 in step S1618 of FIG. 16.

The screen 171A includes the display area 101A, the input field 171a, the operation button 171b, and the display area 171c.

In the display area 171c of the present embodiment, the question data representing the question input in the input field 171a and the answer data generated by the large-scale language model 511 in response to the question are displayed.

In the example of FIG. 21, the display area 171c includes display areas 171h and 171i. In the display area 171h, the question data representing the question input by the user of the terminal apparatus 600 is displayed.

In the display area 171i, the answer data representing the answer to the question is displayed.

Further, the display area 171i includes display areas 171j and 171k. In the display area 171j, the answer data representing the answer to the question is displayed, and in the display area 171k, information for identifying the internal information used as an information source for the answer (answer information source) and a link indicating the storage destination of the internal information are displayed.

In the example of FIG. 21, the question displayed in the display area 171h is, “How much of Company C's sales comes from special factors?” The answer displayed in the display area 171j is “Approximately 7 billion yen of the sales to Company C comes from special factors.” and the information that identifies the internal information displayed in the display area 171k is displayed as the file name of the internal information 111 and a link indicating the storage location of the internal information 181, “Sales Report.pdf#page5”.

In this embodiment, when a link displayed in the display area 171k is selected, the corresponding internal information may be displayed on screen 171A.

In the present embodiment, “Sales Report.pdf#page5” is the internal information 181 illustrated in FIG. 18, so when the link displayed in the display area 171g is selected, the internal information 181 illustrated in FIG. 18 is displayed on screen 171A. The internal information 181 includes the bar graph 111C-1 that is an object and supplementary information for bar graph 111C-1. The supplementary information for bar graph 111C-1 indicates that Company C has sales of approximately 7 billion yen as a special factor.

That is, the answer data displayed in the display area 171k is generated based on information derived from the object included in the internal information 181 and the supplementary information regarding the object.

In the present embodiment described above, by including the supplementary information for the object in a prompt requesting a textual description (textual representation) of an object, a detailed textual description of content indicated by the object can be provided. Accordingly, according to the present embodiment, the accuracy of an answer generated using, as an information source, internal information including an object can be increased.

### Third Embodiment

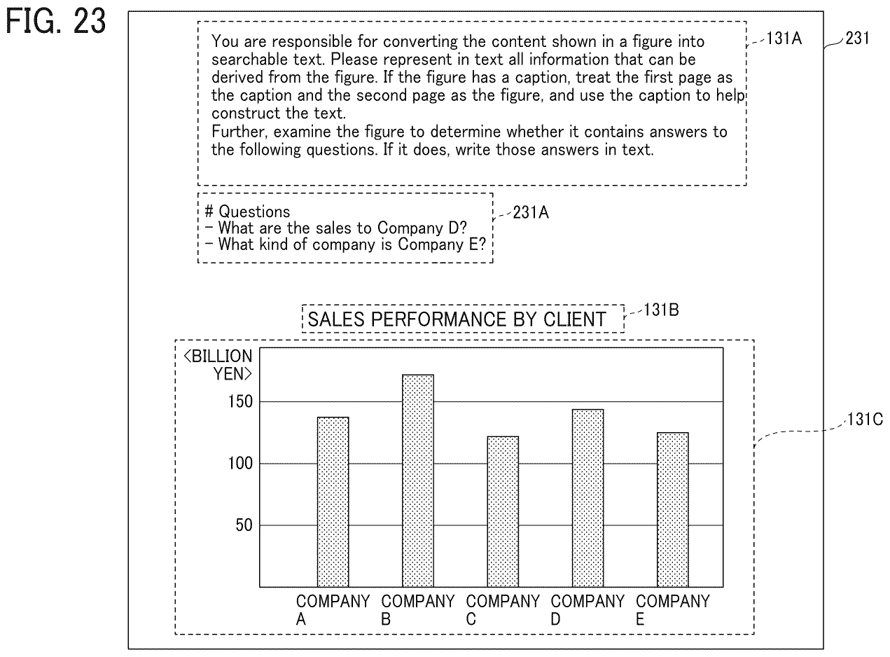

The chat system according to a third embodiment is described below with reference to FIGS. 22 and 23. In the third embodiment, the difference from the first embodiment is that when appropriate answer data to question data input by the user of the terminal apparatus 600 has not been output, the question represented by the question data is included in a prompt requesting the textual description. In the following description of the third embodiment, differences from the first embodiment are described. The same reference numerals are given to the same or corresponding functions or configurations as those of the first embodiment, and redundant descriptions thereof are omitted or simplified appropriately.

FIG. 22 is a sequence diagram illustrating an example operation performed by the chat system according to the third embodiment.

The process illustrated in FIG. 22 may be performed when appropriate answer data is not obtained from the large-scale language model 511 for question data input from the terminal apparatus 600 in the question answering process illustrated in FIG. 16.

The case where appropriate answer data is not obtained is, for example, a case where answer data to question data indicates that “The answer is not registered”. In other words, the case where appropriate answer data is not obtained may be a case where the information processing apparatus 200 fails to obtain a chunk as a search result of searching the chunk DB 415 in the second storage device 400.

The information processing apparatus 200 of the present embodiment may analyze the content of the answer data obtained from the server 500 and execute the processing of step S2201 and subsequent steps in FIG. 22 when the content of the answer data indicates that a chunk to be used as an information source for an answer is not stored.

In the present embodiment, for example, the user of the terminal apparatus 600 who has input the question data may evaluate whether the content of the answer data is appropriate. In the present embodiment, when the answer is evaluated as inappropriate by the evaluation of the user of the terminal apparatus 600, the processing of step S2201 and subsequent steps in FIG. 22 may be executed.

The processing of step S2201 and subsequent steps in FIG. 22 may be executed following the question answering process when an appropriate answer is not obtained in the question answering process of FIG. 16.

In step S2201, in the chat system 100 of the present embodiment, the analysis instruction unit 257 of the information processing apparatus 200 transmits an analysis instruction for analyzing internal information to the analysis server 550. At this time, the analysis instruction unit 257 may issue an analysis instruction to analyze all internal information stored in the document DB 410. Further, the analysis instruction unit 257 may issue an analysis instruction to analyze the internal information stored in the folder selected in step S1602 of FIG. 16, which is part of the internal information stored in the document DB 410.

The processing from step S2202 to step S2205 of FIG. 22 are substantially the same as the processing from step S909 to step S912 of FIG. 9, and the description thereof is omitted.

The information processing apparatus 200 performs the processing from step S2206 to step S2208 the same number of times as the number of objects included in the internal information.

In step S2206, after the analysis result is held, the prompt generation unit 255 of the information processing apparatus 200 generates a prompt including an image of the object, an image of the caption, and question data for which appropriate answer data has not been obtained, and requesting a textual description of the image of the object. The prompt generated in step S2206 will be described in detail later.

In step S2207, the prompt output unit 256 of the information processing apparatus 200 transmits the generated prompt to the server 500.

The processing from step S2207 to step S2213 of FIG. 22 are substantially the same as the processing from step S914 to step S920 of FIG. 9, and the description thereof is omitted.

The prompt generated in step S2206 of FIG. 22 is described below with reference to FIG. 23. FIG. 23 is a diagram illustrating an example of the prompt generated in the third embodiment.

The prompt 231 includes text data 131A, text data 231A, the image 131B corresponding to the heading 111B, and the image 131C corresponding to the bar graph 111C. The images 131B and 131C are obtained as the analysis result by the analysis server 550.

The text data 231A is question data for when no appropriate answer data is obtained. The text data 231A may include all questions for each of which no appropriate answer has been obtained.

In the present embodiment described above, by including the question for which an appropriate answer has not been obtained in the past, in a prompt requesting a textual description (textual representation) of an object included in internal information, the accuracy of the textual description provided by the large-scale language model 511 can be increased. Accordingly, according to the present embodiment, when a question for which an appropriate answer has not been obtained in the past is input again to the chat system 100, the likelihood of obtaining an appropriate answer can be increased.

### Fourth Embodiment

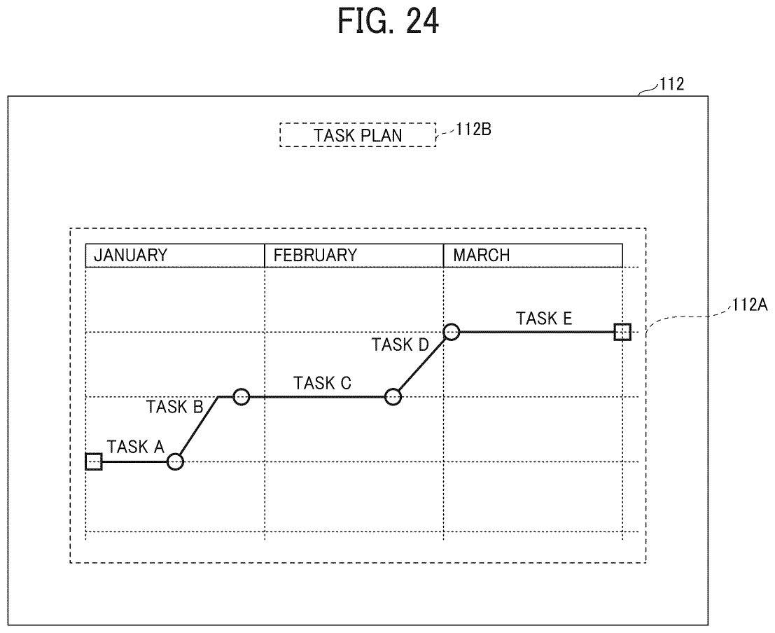

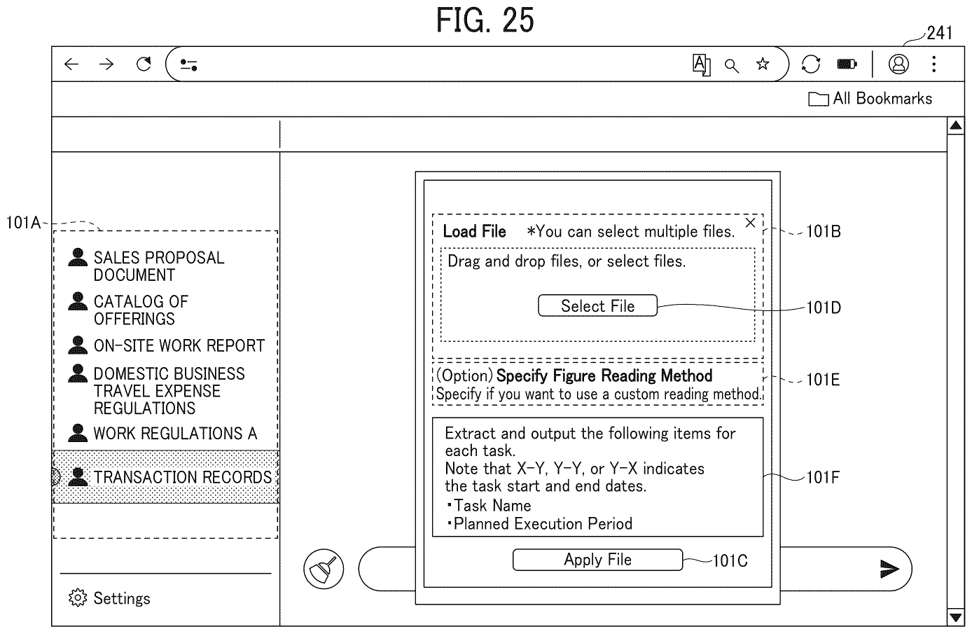

The chat system according to a fourth embodiment is described below with reference to FIGS. 24 and 25. The fourth embodiment is different from the first embodiment in that a prompt requesting a textual description of internal information (requesting to convert internal information into a textual representation) includes information indicating a method for reading the objects included in the internal information. Therefore, in the following description of the fourth embodiment, differences from the first embodiment are described. In the following description of the fourth embodiment, the same reference numerals are given to the same or corresponding functions or configurations as those of the first embodiment, and redundant descriptions thereof are omitted or simplified appropriately.

Some of the objects included in the internal information are created according to a predetermined rule. When representing such an object as a textual description by the large-scale language model 511, the large-scale language model 511 is trained with the predetermined rule.

In this embodiment, when an object included in internal information is created according to a predetermined rule, a prompt requesting a textual description of the internal information (requesting to convert internal information into a textual representation) includes information indicating the predetermined rule. The information indicating the predetermined rule is an example of information indicating a method for reading an object.

FIG. 24 is a diagram illustrating an example of internal information according to the fourth embodiment. Internal information 112 illustrated in FIG. 24 includes a task planning table 112A and a heading 112B for the task planning table 112A. The task planning table 112A and the heading 112B are data other than text data and are objects included in the internal information 112. In addition, the task planning table 112A is an object created based on a predetermined table.

In this embodiment, when internal information that includes such an object is uploaded, a predetermined rule for reading the object is input by the administrator operating the terminal apparatus 700 with which the internal information is uploaded. An internal information registration screen according to the present embodiment is described below.

FIG. 25 is a diagram illustrating an example of an internal information registration screen according to the first embodiment. A screen 241 illustrated in FIG. 25 is an example of the registration screen displayed on the terminal apparatus 700 in step S903 in FIG. 9.

The screen 241 includes the display areas 101A and 101B, the operation button 101C, a display area 101E, and an input field 101F.

In the display area 101E, a message prompting the user to specify a method for reading an object included in the internal information to be uploaded is displayed. The input field 101F is an input field for inputting a method for reading an object.

In this embodiment, in response to receiving a selection of the operation button 101C performed after the internal information to be uploaded is selected, and a method for reading an object included in the internal information is input in the input field 101F on the screen 241, the terminal apparatus 700 transmits the information indicating the method for reading an object input in the input field 101F along with the selected internal information. The information indicating the method for reading an object is text data.

After receiving the internal information and the information indicating the method for reading an object, the information processing apparatus 200 generates a prompt requesting a textual description of the internal information (requesting to convert internal information into a textual representation) such that the prompt includes an image of the object, which is the analysis result obtained by the analysis server 550 the internal information, the information indicating the method for reading an object.

Specifically, in this embodiment, the image of the task planning table 112A, the image of the heading 112B, and the text data entered in the input field 101F are included in the prompt requesting a textual description of the internal information 112 (requesting to convert the internal information 112 into a textual representation).

In the present embodiment described above, by including the image of an object and information indicating a method for reading the object in the prompt input to the large-scale language model 511, the large-scale language model 511 can be trained with the method for reading the object. Accordingly, according to the present embodiment, even internal information including an object created according to a predetermined rule can be represented as a textual representation (textual description) and can be used as an information source for an answer to a question.

Each of the embodiments described above can be applied, for example, to a chatbot system for a product support department in a manufacturing industry.

By applying the embodiment to such a system, the chat system for a product support department can use graphical data (visual data) including figures and tables such as performance graphs, structural diagrams, or flowcharts included in product manuals, troubleshooting guides, or technical specifications, as information sources for outputting answers to questions from customers. As a result, the accuracy of an answer to a question can be increased.

Further, each of the embodiments described above can be applied to a chat system that handles inquiries regarding product structure. By applying the embodiment to such a system, for example, when a question “Please explain the structure of the cooling system in the new product X? How is it different from the previous model?” is entered, the answer can be output based on information in which the structural diagrams of the new and old cooling systems included in the technical specifications are represented as textual descriptions. As a result, according to the present embodiment, the accuracy of an answer to a question can be increased.

Further, each of the embodiments described above can be applied to a chat system that handles inquiries related to troubleshooting. By applying the embodiment to such a system, for example, when a question “The power of the new product X does not turn on. Please tell me the possible causes and solutions?” is entered, an answer can be output based on information in which a flowchart for power system diagnostics is represented as textual description. As a result, according to the present embodiment, the accuracy of an answer to a question can be increased.

As described above, by applying the embodiment to various chat systems, comprehensive answers can be generated using both text and graphical data (visual data). Further, according to the embodiment, a clear and understandable answer can be generated based on a relevant figure or table in response to a question from a user. Further, according to the embodiment, by utilizing the quantitative data and visual information included in a figure or table, a more accurate and specific answer can be output.

According to the embodiment, by automatically analyzing an object (graphical or visual data) and representing the object as a textual description, the workload involved in manually creating explanatory text for figures and tables can be reduced.

In the embodiment, when an appropriate answer to a question has not been obtained, a prompt that includes the question is input to the large-scale language model 511 to represent internal information as a textual description (convert internal information into a textual representation), the accuracy of the answers increases over time, and the need for human support will decrease. In the embodiment, when new product information or technical documents are added, the added information, including figures or tables, are represented as a textual description to be used as an information source in generating an answer. Accordingly, new information is immediately reflected in the answer.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described in the above-described embodiments is merely one example of multiple computing environments for implementing the embodiments disclosed herein.

In some embodiments, the information processing apparatus 200 includes multiple computing devices, such as a server cluster. The multiple computing devices are configured to communicate with each other through any type of communication links, including a network or a shared memory, to perform the processes disclosed herein. In substantially the same manner, for example, the information processing apparatus 200 includes such multiple computing devices configured to communicate with one another.

Further, the information processing apparatus 200 may be configured to share the processing steps disclosed herein in various combinations. For example, the processes executed by one or more functional units may be performed by any one of the computing devices operating as the information processing apparatus 200. Similarly, the functions executed by one or more functional units may be performed by any one of the computing devices operating as the information processing apparatus 200. The functional elements of the information processing apparatus 200 may be integrated into one server apparatus or may be divided into a plurality of apparatuses.

The information processing apparatus 200 may be any apparatus having a communication function. Other examples of the information processing apparatus 200 include, but not limited to, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

Aspects of the present disclosure are, for example, as follows.

### Aspect 1

An information processing apparatus searches a file stored in a storage unit and outputs answer data when receiving an input of question data from a user via a terminal apparatus.

The information processing apparatus includes a reception unit to receive a registration request to store a file in the storage unit, a prompt generation unit to generate a prompt to output content that can be derived from an object included in the file, a transmission unit to transmit the prompt generated by the prompt generation unit and the object to a large language model, and a registration unit that registers a result output by the large-scale language model in the storage unit in association with the file for which the registration request is received.

### Aspect 2

The information processing apparatus according to Aspect 1 further includes an input reception unit to receive an input of question data, a prompt output unit to output, to the large-scale language model, a prompt requesting to generate answer data to the question data based on the file when the input of the question data is received, and an information output unit that outputs, to a terminal apparatus, answer data output by the large-scale language model based on the prompt output from the prompt output unit and information indicating a storage destination of the file used as an information source for the answer data.

When the information indicating the storage destination displayed on the terminal apparatus is selected and the object included in the file used as the information source for the answer data is data other than text data, the information output unit cause the file including the object to be displayed on the terminal apparatus.

### Aspect 3

In the information processing apparatus according to Aspect 2, the prompt generation unit generates the prompt requesting a textual description of an image that is the object extracted from the file for which the registration request to store the file in the storage unit has been received.

The prompt output unit outputs the prompt requesting the textual description of the image of the object to the large-scale language model.

The information output unit outputs, to the storage unit, text data representing the textual description of the object. The text data is obtained by the large-scale language model.

### Aspect 4

The information processing apparatus according to Aspect 3 further includes an embedding unit to embed the text data representing the textual description of the object in place of the object in the file, and a segmentation unit to divide the file in which the text data is embedded in place of the object into a plurality of units of information.

The information output unit outputs, to the storage unit, the plurality of units of information.

### Aspect 5

In the information processing apparatus according to Aspects 3 or 4, the prompt generation unit generates the prompt requesting the textual description of the image of the object and including an image of a caption of the object extracted from the file.

### Aspect 6

In the information processing apparatus according to any one of Aspects 3 to 5, the prompt generation unit generates the prompt requesting the textual description of the image of the object and including supplementary information related to the object extracted from the file.

### Aspect 7

In the information processing apparatus according to any one of Aspects 3 to 6, the prompt generation unit generates the prompt requesting the textual description of the image of the object and including a question represented by the question data, depending on an answer represented by the answer data output by the large-scale language model.

### Aspect 8

In the information processing apparatus according to any one of Aspects 3 to 7, when information for specifying a method for reading the object included in the file is input along with the registration request to store the file in the storage unit, the prompt generation unit generates the prompt requesting the textual description of the image of the object and including the image of the object and the information for specifying the method for reading the object.

### Aspect 9

An information processing system according to Aspect 9 includes an information processing apparatus and a terminal apparatus communicably connected with the information processing apparatus.

The information processing apparatus searches a file stored in a storage unit and outputs answer data when receiving an input of question data from a user via the terminal apparatus.

The information processing apparatus includes a reception unit to receive a registration request to store a file in the storage unit, a prompt generation unit to generate a prompt to output content derived from an object included in the file for which the registration request has been received, a transmission unit to transmit the prompt generated by the prompt generation unit and the object to a large-scale language model, and a registration unit to register a result output by the large-scale language model in the storage unit in association with the file for which the registration request is received.

### Aspect 10

An information processing method according to Aspect 9 is performed by an information processing apparatus to search a file stored in a storage unit and outputs answer data when receiving an input of question data from a user via the terminal apparatus.

The information processing method includes receiving a registration request to store a file in the storage unit, generating a prompt to output content that can be derived from an object included in the file, transmitting the prompt generated by the prompt generation unit and the object to a large language model, and registering a result output by the large-scale language model in the storage unit in association with the file for which the registration request is received.

### Aspect 11

A program according to Aspect 11 causes an information processing apparatus that searches a file stored in a storage unit and outputs answer data when receiving an input of question data from a user via the terminal apparatus to perform a method.

The method includes receiving a registration request to store a file in the storage unit, generating a prompt to output content that can be derived from an object included in the file, transmitting the prompt generated by the prompt generation unit and the object to a large language model, and registering a result output by the large-scale language model in the storage unit in association with the file for which the registration request is received.

According to an aspect of the disclosure, registering information derived from a file, as information to be searched to output answer data to a question, can be assisted.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus, comprising circuitry configured to:
receive a registration request to store a file in a memory;
generate a prompt to output content derived from an object included in the file;
transmit the prompt and the object to a large-scale language model;
store, in the memory, a result output by the large-scale language model in association with the file;
search the memory for the file to obtain answer data that is to be generated based on the file, in response to input of question data received via a terminal apparatus; and
output, to the terminal apparatus, the answer data based on the file.

2. The information processing apparatus of claim 1, wherein the circuitry is further configured to:
receive the input of the question data;
output, to the large-scale language model, another prompt requesting to generate the answer data to the question data based on the file, in response to receiving the input of the question data; and
output, to the terminal apparatus, the answer data and information indicating a storage destination of the file used as an information source for the answer data, the answer data being output by the large-scale language model in response to said another prompt, wherein,
when the information indicating the storage destination is selected on a display of the terminal apparatus and the object that is non-text data is included in the file to be used as the information source for the answer data, the circuitry is further configured to output screen information to display, on the display of the terminal apparatus, the file including the object.

3. The information processing apparatus of claim 2, wherein
the prompt includes an image that is the object extracted from the file for which the registration request has been received and requests a textual representation of the image of the object, and
the circuitry is further configured to:
output the prompt requesting the textual representation of the image of the object to the large-scale language model; and
store, in the memory, text data corresponding to the textual representation of the object, the text data being obtained by the large-scale language model.

4. The information processing apparatus of claim 3, wherein the circuitry is further configured to:
embed the text data corresponding to the textual representation of the object in place of the object in the file;
divide the file in which the text data is embedded in place of the object into a plurality of units of information; and
store, in the memory, the plurality of units of information.

5. The information processing apparatus of claim 3, wherein
the prompt requesting the textual representation of the image of the object includes another image of a caption of the object extracted from the file.

6. The information processing apparatus of claim 3, wherein
the prompt requesting the textual representation of the image of the object includes supplementary information related to the object extracted from the file.

7. The information processing apparatus of claim 3, wherein
the prompt requesting the textual representation of the image of the object includes a question represented by the question data, depending on an answer represented by the answer data output by the large-scale language model.

8. The information processing apparatus of claim 3, wherein,
when the registration request to store the file in the memory is received along with an input of information for specifying a method for reading the object included in the file, the prompt requesting the textual representation of the image of the object includes the image of the object and the information for specifying the method for reading the object.

9. An information processing method performed by an information processing apparatus, the information processing method comprising:
receiving a registration request to store a file in a memory;
generating a prompt to output content derived from an object included in the file;
transmitting the prompt and the object to a large-scale language model;
storing, in the memory, a result output by the large-scale language model in association with the file;
searching the memory for the file to obtain answer data that is based on the file, in response to question data received via a terminal apparatus connected to the information processing apparatus; and
outputting, to the terminal apparatus, the answer data based on the file.

10. A non-transitory recording medium storing a plurality of instructions which, when executed by one or more processors, causes the one or more processors to perform a method, the method comprising:
receiving a registration request to store a file in a memory;
generating a prompt to output content derived from an object included in the file;
transmitting the prompt and the object to a large-scale language model;
storing, in the memory, a result output by the large-scale language model in association with the file;
searching the memory for the file to obtain answer data that is based on the file, in response to question data received via a terminal apparatus; and
outputting, to the terminal apparatus, the answer data based on the file.
